(19) United States
(12) Patent Application Publication
(10) Pub. No.: US 2026/0113627 A1
(43) Pub. Date: Apr. 23, 2026

(54) ENHANCED FRAME EXCHANGE FOR ROAMING IN WIRELESS COMMUNICATIONS

(71) Applicants: Po-Kai Huang, San Ramon, CA (US); Ido Ouzieli, Tel Aviv (IL); Johannes Berg, Detmold (DE); Laurent Cariou, Milizac (FR); Danny Alexander, Neve Efraim Monoson (IL); Danny Ben-Ari, Hasharon Hatichon (IL)

(72) Inventors: Po-Kai Huang, San Ramon, CA (US); Ido Ouzieli, Tel Aviv (IL); Johannes Berg, Detmold (DE); Laurent Cariou, Milizac (FR); Danny Alexander, Neve Efraim Monoson (IL); Danny Ben-Ari, Hasharon Hatichon (IL)

(21) Appl. No.: 19/424,466

(22) Filed: Dec. 18, 2025

Related U.S. Application Data
(60) Provisional application No. 63/759,484, filed on Feb. 17, 2025.
(60) Provisional application No. 63/858,101, filed on Aug. 5, 2025.
(60) Provisional application No. 63/884,598, filed on Sep. 19, 2025.

(51) Int. Cl. H04W 12/041; H04L 9/08; H04W 36/18

(52) U.S. Cl. CPC H04W 12/041; H04L 9/0841; H04W 36/18

(57) ABSTRACT

Systems, methods, and devices are disclosed for managing a transition of a multi-link device (MLD) in a wireless communication network. A device may cause to send a transition preparation request frame to a currently connected access point (AP) MLD, indicating a request to transition to a single target AP MLD. The transition preparation request frame may include a reconfiguration multilink element signaling a medium access control (MAC) address of the target AP MLD, a seamless mobility domain basic service set (BSS) transition parameters element signaling a listen interval, and a Diffie-Hellman parameter element for generating a new pairwise transient key (PTK). After identifying a successful transition preparation response frame from the AP MLD, the device may cause to send a transition execution request frame within a timeout period and subsequently identify a transition execution response frame.

### CROSS-REFERENCE TO RELATED PATENT APPLICATION(S)

This application claims the benefit of U.S. Provisional Application No. 63/759,484, filed Feb. 17, 2025, of U.S. Provisional Application No. 63/858,101, filed Aug. 5, 2025, and of U.S. Provisional Application No. 63/884,598, filed Sep. 19, 2025, the disclosures of which are incorporated herein by reference as if set forth in full.

### BACKGROUND

Wireless devices are becoming more prevalent, necessitating efficient access to wireless channels. Standards are evolving to enhance connectivity, integrating advanced technologies in modern networks.

### BRIEF DESCRIPTION OF THE DRAWINGS

FIG. 1 is a network diagram illustrating an example network environment for enhanced roaming, in accordance with one or more example embodiments of the present disclosure.

FIG. 2 is an example flow of a process for enhanced roaming, in accordance with one or more example embodiments of the present disclosure.

FIG. 3 is an example flow of a process for enhanced roaming, in accordance with one or more example embodiments of the present disclosure.

FIG. 4 is an example flow of a process for enhanced roaming, in accordance with one or more example embodiments of the present disclosure.

FIG. 5A illustrates a flow diagram of illustrative process for an enhanced roaming system, in accordance with one or more example embodiments of the present disclosure.

FIG. 5B illustrates a flow diagram of illustrative process for an enhanced roaming system, in accordance with one or more example embodiments of the present disclosure.

FIG. 6 illustrates a functional diagram of an exemplary communication station that may be suitable for use as a user device, in accordance with one or more example embodiments of the present disclosure.

FIG. 7 illustrates a block diagram of an example machine upon which any of one or more techniques (e.g., methods) may be performed, in accordance with one or more example embodiments of the present disclosure.

FIG. 8 is a block diagram of a radio architecture in accordance with some examples.

FIG. 9 illustrates an example front-end module circuitry for use in the radio architecture of FIG. 8, in accordance with one or more example embodiments of the present disclosure.

FIG. 10 illustrates an example radio IC circuitry for use in the radio architecture of FIG. 8, in accordance with one or more example embodiments of the present disclosure.

FIG. 11 illustrates an example baseband processing circuitry for use in the radio architecture of FIG. 8, in accordance with one or more example embodiments of the present disclosure.

### DETAILED DESCRIPTION

The following description and the drawings sufficiently illustrate specific embodiments to enable those skilled in the art to practice them. Other embodiments may incorporate structural, logical, electrical, process, algorithm, and other changes. Portions and features of some embodiments may be included in, or substituted for, those of other embodiments. Embodiments set forth in the claims encompass all available equivalents of those claims.

The IEEE 802.11 technical standards define wireless communications for Wi-Fi® (referred to herein as Wi-Fi), including for roaming and multi-link devices (MLDs). Roaming in Wi-Fi refers to a station device (STA) switching from an access point (AP) to another AP as the physically moves locations so that the STA does not lose wireless connectivity. MLDs refer to APs (AP MLDs) and STAs (MLDs or non-AP MLDs) with multiple logical entities that can concurrently maintain communication links (e.g., an MLD may include multiple STAs/APs each with their own communication link concurrently operated).

Wi-Fi 8 (e.g., IEEE 802.11bn or ultra high reliability (UHR)) is the next generation of Wi-Fi and a successor to the IEEE 802.11be (Wi-Fi 7) standard. In line with all previous Wi-Fi standards, Wi-Fi 8 will aim to improve wireless performance in general along with introducing new and innovative features to further advance Wi-Fi technology.

The relationship between roaming preparation and roaming request is not specified. The roaming preparation should not be an independent frame that may happen long time before the roam request/response since the transferred context may become out of date.

The roaming preparation should not prepare more than one target AP MLD, which complicates the potential operation after roaming finishes.

There should also be a deadline between roaming request/response and preparation request/response such that the information is not held at target AP MLD forever.

Beyond the exchange with current AP MLD to do the roaming. The frame exchange directly with Target AP MLD is also not specified. Note that it is possible that when roaming happens, the connection to current AP MLD is already lost. As a result, roaming exchange directly with target AP MLD is required. There are no previous solutions to solve this problem.

In addition, the exact format of preparation request response and roaming request response are not defined. The reason is that a different frame format may imply different potential operation change. For example, traditionally a reassociation request response is used during roaming, which ends the connection with the current AP MLD right away. Hence, it is not considered to be suitable for preparation request/response. As another example, link reconfiguration request and link reconfiguration response can help to setup links, but the added link can immediately be used, which does not align with the operation that after preparation the setup link with target AP MLD still cannot be used.

Reassociation Request/Response frame and link reconfiguration request/response frames have been proposed for preparation request/response frame or roaming request/response frames. UHR Link Reconfiguration response frame is proposed to serve the purpose of preparation response or execution response.

The Key Data includes multiple KDEs. The KDE format is the following with 6 bytes header. Examples include MLO GTK/IGTK/BIGTK KDE. For the Group Key Data field, the Key Data length can only indicate at most 255 bytes. However, if the size is counted, it can be seen that only keys for two links under 128 bit and keys for one link under 256 bits can fit in. For UHR Link Reconfiguration Response that is used for link preparation with a target AP MLD, the number of links is common to be 3, and the use case is then not supported.

Another issue is that Basic multi-link elements are used to include all the information of target AP MLD. However, currently there is no element inheritance defined for UHR Link Reconfiguration Response or Link Reconfiguration Response defined in EHT.

There is no previous solution for UHR Link Reconfiguration Request.

Example embodiments of the present disclosure relate to systems, methods, and devices for frame exchange for roaming.

In one or more embodiments, an enhanced roaming preparation system may facilitate that the preparation request frame shall only request to prepare for one target AP MLD.

In one or more embodiments, an enhanced roaming preparation system may define a timeout value such that if the roaming request frame is not sent within the timeout value, then the target AP MLD shall delete all the contexts maintained for non-AP MLD. The timeout value is indicated in the initial connection and is set constant across the seamless mobility domain.

In one or more embodiments, an enhanced roaming preparation system may define message exchange with the target AP MLD directly to mimic the operation of exchange with current AP MLD by having two additional messages to verify the roaming.

The roaming preparation operation is simplified to be one at a time. How the target AP MLD maintains the information is defined and mandated to be the same across the entire domain.

Other example embodiments of the present disclosure relate to systems, methods, and devices for frame format of roaming preparation request/response, roaming request/response, and operation state.

One or more embodiments in this disclosure are as follows:
The frame format and the required operation to fit the UHR roaming flow are discussed.
Option 1: Discusses the new action frame and the required operations defined for the new action frame.
Option 2: Explores reuse of link reconfiguration request/response and changes to the existing operation under link reconfiguration request/response, with missing fields needed for the operation also defined.

One or more advantages include: the format of preparation request/response and roaming request/response and the corresponding operations are defined.

Other example embodiments of the present disclosure relate to systems, methods, and devices for UHR Link Reconfiguration Response frame design.

In one or more embodiments, it is proposed to use Key delivery element to include group key KDE rather than using a specific group key data field. Key delivery element is flexible to include whatever number of KDEs and element fragmentation can be used for the solution to be scalable.

In one or more embodiments, it is proposed to use the first per STA profile as the element inheritance target, so element inheritance can be used to reduce the size of the frame.

Size issues of the group key delivery is resolved, and preparation with more than two links can be done. Inheritance rules are proposed to reduce the size of the preparation response.

In one or more embodiments, a device or a system may comprise one or more components, which may include one or more of: apparatus, station (STA), access point (AP), and/or other network elements. At its most basic configuration, the device or system includes one or more processors, memory, and instructions. The processor(s) may be implemented using general-purpose microprocessors, digital signal processors (DSPs), field-programmable gate arrays (FPGAs), or other suitable computational entities capable of performing calculations or manipulations of information. The memory may include RAM, ROM, flash memory, or other storage media suitable for storing instructions and data necessary for system operation. These components, individually or in combination, enable the execution of processes that facilitate communication and functionality within the system.

The above descriptions are for purposes of illustration and are not meant to be limiting. Numerous other examples, configurations, processes, algorithms, etc., may exist, some of which are described in greater detail below. Example embodiments will now be described with reference to the accompanying figures.

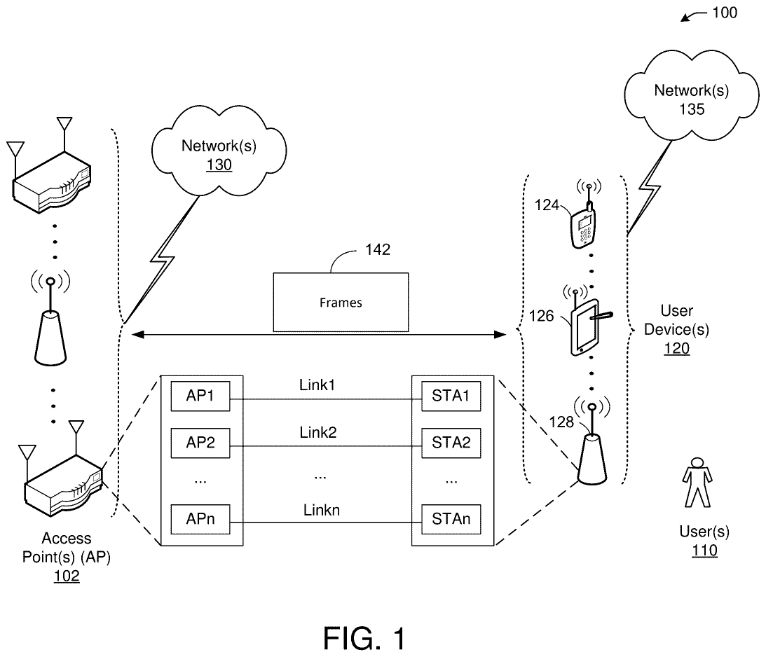

FIG. 1 is a network diagram illustrating an example network environment of enhanced roaming preparation, according to some example embodiments of the present disclosure. Wireless network 100 may include one or more user devices 120 and one or more access points(s) (AP) 102, which may communicate in accordance with IEEE 802.11 communication standards. The user device(s) 120 may be mobile devices that are non-stationary (e.g., not having fixed locations) or may be stationary devices.

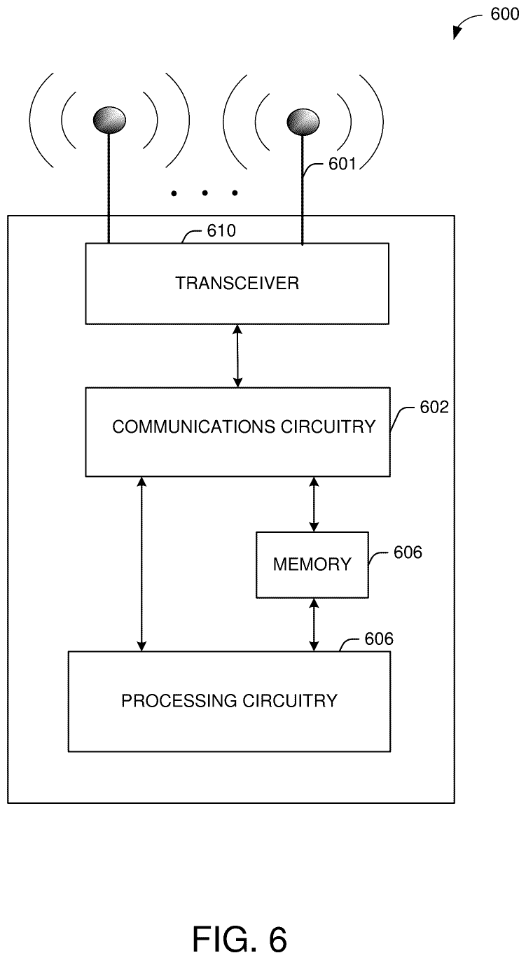

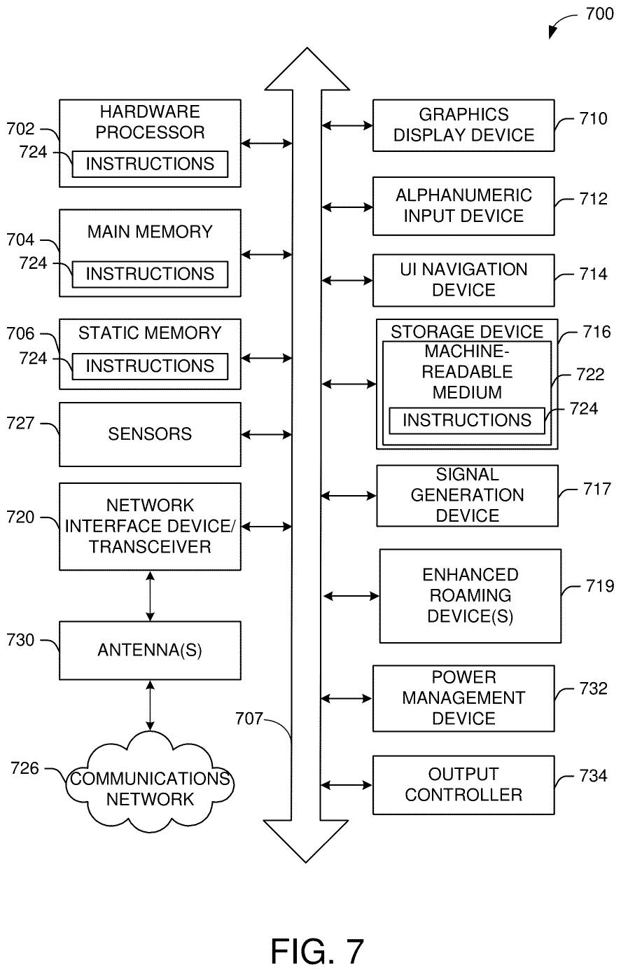

In some embodiments, the user devices 120 and the AP 102 may include one or more computer systems similar to that of the functional diagram of FIG. 6 and/or the example machine/system of FIG. 7.

One or more illustrative user device(s) 120 and/or AP(s) 102 may be operable by one or more user(s) 110. It should be noted that any addressable unit may be a station (STA). An STA may take on multiple distinct characteristics, each of which shape its function. For example, a single addressable unit might simultaneously be a portable STA, a quality-of-service (QoS) STA, a dependent STA, and a hidden STA. The one or more illustrative user device(s) 120 and the AP(s) 102 may be STAs. The one or more illustrative user device(s) 120 and/or AP(s) 102 may operate as a personal basic service set (PBSS) control point/access point (PCP/AP). The user device(s) 120 (e.g., 124, 126, or 128) and/or AP(s) 102 may include any suitable processor-driven device including, but not limited to, a mobile device or a non-mobile, e.g., a static device. For example, user device(s) 120 and/or AP(s) 102 may include, a user equipment (UE), a station (STA), an access point (AP), a software enabled AP (SoftAP), a personal computer (PC), a wearable wireless device (e.g., bracelet, watch, glasses, ring, etc.), a desktop computer, a mobile computer, a laptop computer, an Ultrabook™ computer, a notebook computer, a tablet computer, a server computer, a handheld computer, a handheld device, an internet of things (IoT) device, a sensor device, a PDA device, a handheld PDA device, an on-board device, an off-board device, a hybrid device (e.g., combining cellular phone functionalities with PDA device functionalities), a consumer device, a vehicular device, a non-vehicular device, a mobile or portable device, a non-mobile or non-portable device, a mobile phone, a cellular telephone, a PCS device, a PDA device which incorporates a wireless communication device, a mobile or portable GPS device, a DVB device, a relatively small computing device, a non-desktop computer, a “carry small live large” (CSLL) device, an ultra mobile device (UMD), an ultra mobile PC (UMPC), a mobile internet device (MID), an “origami” device or computing device, a device that supports dynamically composable computing (DCC), a context-aware device, a video device, an audio device, an A/V device, a set-top-box (STB), a blu-ray disc (BD) player, a BD recorder, a digital video disc (DVD) player, a high definition (HD) DVD player, a DVD recorder, a HD DVD recorder, a personal video recorder (PVR), a broadcast HD receiver, a video source, an audio source, a video sink, an audio sink, a stereo tuner, a broadcast radio receiver, a flat panel display, a personal media player (PMP), a digital video camera (DVC), a digital audio player, a speaker, an audio receiver, an audio amplifier, a gaming device, a data source, a data sink, a digital still camera (DSC), a media player, a smartphone, a television, a music player, or the like. Other devices, including smart devices such as lamps, climate control, car components, household components, appliances, etc. may also be included in this list.

As used herein, the term “Internet of Things (IoT) device” is used to refer to any object (e.g., an appliance, a sensor, etc.) that has an addressable interface (e.g., an Internet protocol (IP) address, a Bluetooth identifier (ID), a near-field communication (NFC) ID, etc.) and can transmit information to one or more other devices over a wired or wireless connection. An IoT device may have a passive communication interface, such as a quick response (QR) code, a radio-frequency identification (RFID) tag, an NFC tag, or the like, or an active communication interface, such as a modem, a transceiver, a transmitter-receiver, or the like. An IoT device can have a particular set of attributes (e.g., a device state or status, such as whether the IoT device is on or off, open or closed, idle or active, available for task execution or busy, and so on, a cooling or heating function, an environmental monitoring or recording function, a light-emitting function, a sound-emitting function, etc.) that can be embedded in and/or controlled/monitored by a central processing unit (CPU), microprocessor, ASIC, or the like, and configured for connection to an IoT network such as a local ad-hoc network or the Internet. For example, IoT devices may include, but are not limited to, refrigerators, toasters, ovens, microwaves, freezers, dishwashers, dishes, hand tools, clothes washers, clothes dryers, furnaces, air conditioners, thermostats, televisions, light fixtures, vacuum cleaners, sprinklers, electricity meters, gas meters, etc., so long as the devices are equipped with an addressable communications interface for communicating with the IoT network. IoT devices may also include cell phones, desktop computers, laptop computers, tablet computers, personal digital assistants (PDAs), etc. Accordingly, the IoT network may be comprised of a combination of “legacy” Internet-accessible devices (e.g., laptop or desktop computers, cell phones, etc.) in addition to devices that do not typically have Internet-connectivity (e.g., dishwashers, etc.).

The user device(s) 120 and/or AP(s) 102 may also include mesh stations in, for example, a mesh network, in accordance with one or more IEEE 802.11 standards and/or 3GPP standards.

Any of the user device(s) 120 (e.g., user devices 124, 126, 128), and AP(s) 102 may be configured to communicate with each other via one or more communications networks 130 and/or 135 wirelessly or wired. The user device(s) 120 may also communicate peer-to-peer or directly with each other with or without the AP(s) 102. Any of the communications networks 130 and/or 135 may include, but not limited to, any one of a combination of different types of suitable communications networks such as, for example, broadcasting networks, cable networks, public networks (e.g., the Internet), private networks, wireless networks, cellular networks, or any other suitable private and/or public networks. Further, any of the communications networks 130 and/or 135 may have any suitable communication range associated therewith and may include, for example, global networks (e.g., the Internet), metropolitan area networks (MANs), wide area networks (WANs), local area networks (LANs), or personal area networks (PANs). In addition, any of the communications networks 130 and/or 135 may include any type of medium over which network traffic may be carried including, but not limited to, coaxial cable, twisted-pair wire, optical fiber, a hybrid fiber coaxial (HFC) medium, microwave terrestrial transceivers, radio frequency communication mediums, white space communication mediums, ultra-high frequency communication mediums, satellite communication mediums, or any combination thereof.

Any of the user device(s) 120 (e.g., user devices 124, 126, 128) and AP(s) 102 may include one or more communications antennas. The one or more communications antennas may be any suitable type of antennas corresponding to the communications protocols used by the user device(s) 120 (e.g., user devices 124, 126 and 128), and AP(s) 102. Some non-limiting examples of suitable communications antennas include Wi-Fi antennas, Institute of Electrical and Electronics Engineers (IEEE) 802.11 family of standards compatible antennas, directional antennas, non-directional antennas, dipole antennas, folded dipole antennas, patch antennas, multiple-input multiple-output (MIMO) antennas, omnidirectional antennas, quasi-omnidirectional antennas, or the like. The one or more communications antennas may be communicatively coupled to a radio component to transmit and/or receive signals, such as communications signals to and/or from the user devices 120 and/or AP(s) 102.

Any of the user device(s) 120 (e.g., user devices 124, 126, 128), and AP(s) 102 may be configured to perform directional transmission and/or directional reception in conjunction with wirelessly communicating in a wireless network. Any of the user device(s) 120 (e.g., user devices 124, 126, 128), and AP(s) 102 may be configured to perform such directional transmission and/or reception using a set of multiple antenna arrays (e.g., DMG antenna arrays or the like). Each of the multiple antenna arrays may be used for transmission and/or reception in a particular respective direction or range of directions. Any of the user device(s) 120 (e.g., user devices 124, 126, 128), and AP(s) 102 may be configured to perform any given directional transmission towards one or more defined transmit sectors. Any of the user device(s) 120 (e.g., user devices 124, 126, 128), and AP(s) 102 may be configured to perform any given directional reception from one or more defined receive sectors.

MIMO beamforming in a wireless network may be accomplished using RF beamforming and/or digital beamforming. In some embodiments, in performing a given MIMO transmission, user devices 120 and/or AP(s) 102 may be configured to use all or a subset of its one or more communications antennas to perform MIMO beamforming.

Any of the user devices 120 (e.g., user devices 124, 126, 128), and AP(s) 102 may include any suitable radio and/or transceiver for transmitting and/or receiving radio frequency (RF) signals in the bandwidth and/or channels corresponding to the communications protocols utilized by any of the user device(s) 120 and AP(s) 102 to communicate with each other. The radio components may include hardware and/or software to modulate and/or demodulate communications signals according to pre-established transmission protocols. The radio components may further have hardware and/or software instructions to communicate via one or more Wi-Fi and/or Wi-Fi direct protocols, as standardized by the Institute of Electrical and Electronics Engineers (IEEE) 802.11 standards. In certain example embodiments, the radio component, in cooperation with the communications antennas, may be configured to communicate via 2.4 GHz channels (e.g. 802.11b, 802.11g, 802.11n, 802.11ax), 5 GHz channels (e.g. 802.11n, 802.11ac, 802.11ax, 802.11be, 802.11bn, etc.), 6 GHz channels (e.g., 802.11ax, 802.11be, 802.11bn, etc.), or 60 GHz channels (e.g. 802.11ad, 802.11ay). 800 MHz channels (e.g. 802.11ah). The communications antennas may operate at 28 GHz and 40 GHz. It should be understood that this list of communication channels in accordance with certain 802.11 standards is only a partial list and that other 802.11 standards may be used (e.g., Next Generation Wi-Fi, or other standards). In some embodiments, non-Wi-Fi protocols may be used for communications between devices, such as Bluetooth, dedicated short-range communication (DSRC), Ultra-High Frequency (UHF) (e.g. IEEE 802.11af, IEEE 802.22), white band frequency (e.g., white spaces), or other packetized radio communications. The radio component may include any known receiver and baseband suitable for communicating via the communications protocols. The radio component may further include a low noise amplifier (LNA), additional signal amplifiers, an analog-to-digital (A/D) converter, one or more buffers, and digital baseband.

In one embodiment, and with reference to FIG. 1, a user device 120 may be in communication with one or more APs 102. For example, one or more APs 102 may exchange frames 142 with one or more user devices 120, such as roaming frames, roaming preparation frames, uplink and downlink frames, and other frames as described herein.

The one or more APs 102 may be multi-link devices (MLDs) and the one or more user device 120 may be non-AP MLDs. Each of the one or more APs 102 may comprise a plurality of individual APs (e.g., AP1, AP2, . . . , APn, where n is an integer) and each of the one or more user devices 120 may comprise a plurality of individual STAs (e.g., STA1, STA2, . . . , STAn). The AP MLDs and the non-AP MLDs may set up one or more links (e.g., Link1, Link2, . . . , Linkn) between each of the individual APs and STAs.

It is understood that the above descriptions are for the purposes of illustration and are not meant to be limiting.

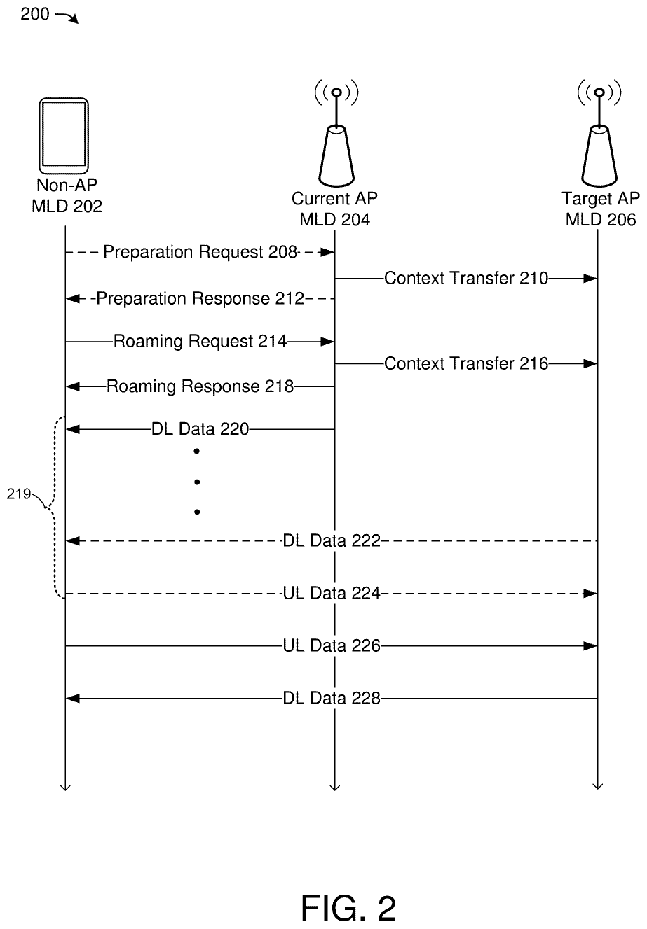

FIG. 2 is an example flow of a process 200 for enhanced roaming, in accordance with one or more example embodiments of the present disclosure.

Referring to FIG. 2, the process 200 may involve a non-AP MLD 202, a current AP MLD 204 to which the non-AP MLD 202 is associated, and a target AP MLD 206 to which the non-AP MLD 202 intends to roam. To improve performance and speed up the roaming exchange, the process 200 may optionally begin with a preparation phase. The non-AP MLD 202 may transmit an optional Preparation Request frame 208 to the current AP MLD 204. This request may indicate the MAC address of the target AP MLD 206 and include information for setting up links (e.g., an SMD BSS transition parameters element, a Diffie-Hellman parameter, etc.). In response, the current AP MLD 204 may provide a Context Transfer 210 to the target AP MLD 206. This context transfer allows parameters from the existing connection to be transferred, avoiding the need to re-establish them with the target AP MLD 206. Following the context transfer, the current AP MLD 204 may send an optional Preparation Response frame 212 to the non-AP MLD 202 to confirm the preparation. The roaming execution begins when the non-AP MLD 202 sends a Roaming Request frame 214 (also referred to as transition execution request frame) to the current AP MLD 204. Upon receiving the request, the current AP MLD 204 may perform another Context Transfer 216 to the target AP MLD 206 to ensure the target AP has the most up-to-date information, such as security contexts and block acknowledgement (BA) parameters. The current AP MLD 204 then sends a Roaming Response frame 218 (also referred to as a transition execution response frame) to the non-AP MLD 202, finalizing the roaming agreement. Following the roaming response 218, the process 200 enters a data transfer phase that includes a transient period 219 designed to minimize data loss. During this transient period 219, the non-AP MLD 202 may continue to receive downlink (DL) data 220 from the current AP MLD 204, which prevents the loss of in-flight data. Concurrently, or shortly after, the non-AP MLD 202 begins to establish its data connection with the target AP MLD 206. This can optionally include receiving DL data 222 and/or sending uplink (UL) data 224. The transition completes as the non-AP MLD 202 sends UL data 226 to, and/or receives DL data 228 from, the target AP MLD 206, establishing it as the new primary communication point.

The DL data loss is minimized by having the transient period 219 to continue to receive DL data from current AP MLD 204.

The UL data loss is minimized by having non-AP MLD 202 informed by the existing forwarding up data from current AP MLD 204 to continue the data transmission without duplication.

The performance improvement is achieved by having parameters of existing negotiation with current AP MLD 204 be transferred as contexts without the need to reestablish parameters with the target AP MLD 206.

The performance improvement is also achieved by having the potential preparation frame exchange to speed up the roaming exchange.

The design is described below for a frame exchange with the current AP MLD 204 to roam to the target AP MLD 206 in the same seamless mobility domain:

The preparation request frame 208 shall request to prepare for only one target AP MLD.

The preparation request frame 208 may indicate the MAC address of the target AP MLD 206. An element with the MAC address of the target AP MLD 206 is included.

The preparation request frame 208 may include the following information: (a) Listen interval as defined in a Listen Interval field. (b) Next PN to be used by the non-AP MLD 202 when it performs the frame exchange with the target AP MLD 206. As a result, the target AP MLD 206 may initialize the value of all replay counters with the value, and can separate into the next PN to be used by secure control frame and the next PN to be used by data and management frame. (c) Existing PTK if same PTK is used. (d) Diffie-Hellman Parameter element to include the Diffie-Hellman Parameter to be used to derive Diffie-Hellman secret to be used in new PTK generation with the target AP MLD 206 if a different PTK is used. (e) Link setup request using the multi-link element. (f) Next MAC address to be used.

The target AP MLD 206 installs the transfers PTK if the same PTK is used. The target AP MLD 206 computes new PTK based on the DHss derived from the Diffie-Hellman Parameter of the non-AP MLD 202 and the Diffie-Hellman Parameter of itself if different PTK is used and installs the new PTK for the non-AP MLD 202. The target AP MLD 206 initiates a replay counter based on the next PN to be used for UL.

The following information is transferred by the current AP MLD 204 to the target AP MLD 206 before sending preparation response to the non-AP MLD: (a) Next PN to be used by the non-AP MLD 202. (b) Next PN to be used by the target AP MLD 206. (c) Current PTK if the same PTK is used. (d) Diffie-Hellman Parameter of the non-AP MLD 202. (e) Link setup request using the multi-link element. (f) Existing BA parameters of non-AP MLD 202 for UL and DL.

The following information is transferred from the target AP MLD 206 to the current AP MLD 204 before sending the preparation response 212: (a) Link setup response using the multi-link element. (b) BA parameters of the target AP MLD 206 for UL existing BA. (c) Diffie-Hellman Parameter of the target AP MLD 206 if a different PTK is used. (d) Define a timeout value such that if the roaming request frame 214 is not sent within the timeout value after the successful preparation request/response exchange, then the target AP MLD 206 shall delete all the contexts maintained for the non-AP MLD 202.

There are multiple ways to signal or determine the timeout value. The timeout value may be indicated in the initial connection and is set constant across the seamless mobility domain. The timeout value may be indicated by the timeout interval element. The timeout value may be defined for the PTK such that if the time expires, then the PTK is deleted. The timeout value may be indicated in the initial connection and is set constant across the seamless mobility domain.—The timeout value may be indicated by the timeout interval element.

Continuing with the roaming request/response exchange after the preparation request/response: (a) If the preparation response 212 is successful, then the non-AP MLD 202 shall continue the roaming request 214 transmission within the timeout indicated in the initial connection to the seamless mobility domain to send roaming request. (b) In the roaming response 218, the current AP MLD 204 will indicate the latest SN that is forward up to the next MAC processing for each UL TID.

Continuing with the roaming request/response exchange without the previous preparation request/response exchange: (a) The roaming request frame 214 may include the following information: (a) Listen interval as defined in a Listen Interval field. (b) Next PN to be used by the non-AP MLD 202 when it performs a frame exchange with the target AP MLD 206. As a result, the target AP MLD 206 can initialize the value of all replay counters with the value and can separate into the next PN to be used by secure control frame and the next PN to be used by data and management frame. This can be 0 due to usage of different PTK. (c) Diffie-Hellman Parameter element to include the Diffie-Hellman Parameter to be used to derive Diffie-Hellman secret to be used in new PTK generation with the target AP MLD 206 if different PTK is used. (d) Link setup request using the multi-link element. (e) Next MAC address to be used. (f) Existing PTK if same PTK is used. (g) The target AP MLD 206 installs the transfers PTK if same PTK is used. The target AP MLD 260 computes new PTK based on the DHss derived from the Diffie-Hellman Parameter of the non-AP MLD 202 and the Diffie-Hellman Parameter of itself if a different PTK is used and installs the new PTK for the non-AP MLD 202. The target AP MLD 206 initiates replay counter based on the next PN to be used for UL.

The following information is transferred by the current AP MLD 204 to the target AP MLD 206 before sending roaming response 218 to the non-AP MLD 202: (a) Next PN to be used by the non-AP MLD 202. (b) Next PN to be used by the target AP MLD 206. (c) Current PTK if same PTK is used. (d) Diffie-Hellman Parameter of the non-AP MLD 202. (e) Link setup request using the multi-link element. (f) Existing BA parameters of non-AP MLD 202 for UL and DL.

The following information is transferred from the target AP MLD 206 to the current AP MLD 204 before sending roaming response 218: (a) Link setup response using the multi-link element. (b) BA parameters of the target AP MLD 206 for UL existing BA. (c) Diffie-Hellman Parameter of the target AP MLD 206 if a different PTK is used. (d) Shifting the design to the frame exchange with the target AP MLD 206. This may happen when connection with the existing AP MLD 204 is lost.

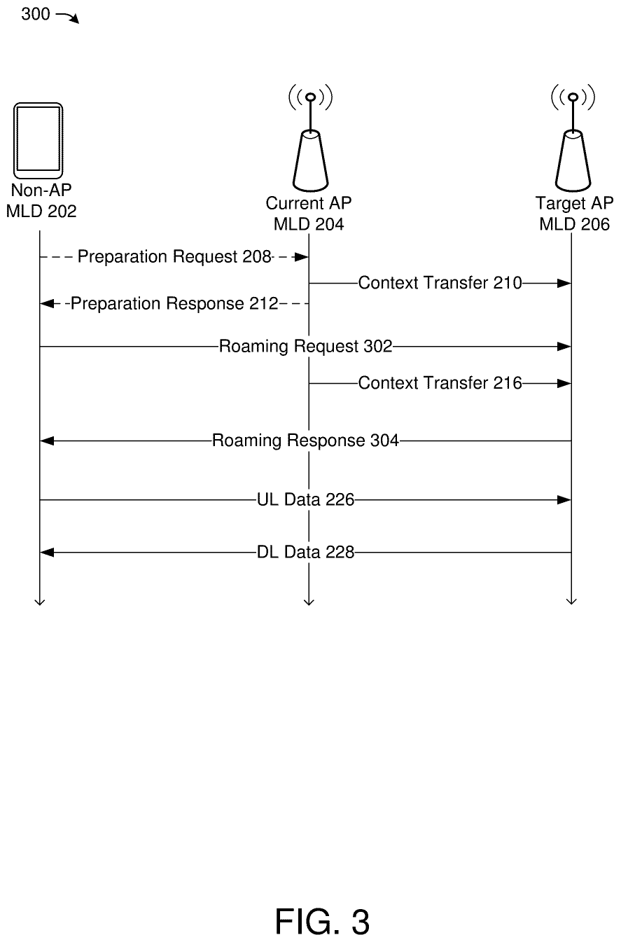

FIG. 3 is an example flow of a process 300 for enhanced roaming, in accordance with one or more example embodiments of the present disclosure.

Referring to FIG. 3, the process 300 may involve the non-AP MLD 202, the current AP MLD 204, and the target AP MLD 206. Similar to the process 200 of FIG. 2, the process 300 may optionally begin with a preparation phase to accelerate the roaming operation. The non-AP MLD 202 may transmit the optional Preparation Request frame 208 to the current AP MLD 204. In response, the current AP MLD 204 may perform the Context Transfer 210 to the target AP MLD 206 and may send an optional Preparation Response frame 212 back to the non-AP MLD 202. A key aspect of the process 300 is the initiation of the roaming execution by the network. The non-AP MLD 204 transmits a Roaming Request frame 302 (also referred to as a transition execution request frame) to the target AP MLD 206. Following the roaming request 302, the current AP MLD 204 performs another Context Transfer 216 to the target AP MLD 206 to ensure all necessary parameters are up-to-date. The target AP MLD 206 then sends a Roaming Response frame 304 to the non-AP MLD 202, which serves as the instruction for the non-AP MLD 202 to transition to the target access point. Upon receiving the roaming response 304, the non-AP MLD 202 completes the handoff by sending UL data 226 to, and/or receiving DL data 228 from, the target AP MLD 206, establishing a new communication link.

Two cases are considered: Case 1: non-AP MLD 202 has done the preparation with the current AP MLD 204 with the target AP MLD 206 and it is still within the timeout. In this case, non-AP MLD 202 directly sends encrypted roaming request frame 302 to the target AP MLD 206. The TA is the link address setup before with the target AP MLD 206. Target AP MLD 206 verifies the encrypted roaming request frame 302 with decryption and replay check. Target AP MLD 206 fetches the contexts of the latest forward up SN of each TID from the current AP MLD 204. Target AP MLD 206 sends the roaming response 304 with the latest forward up SN of each TID from the current AP MLD 204.

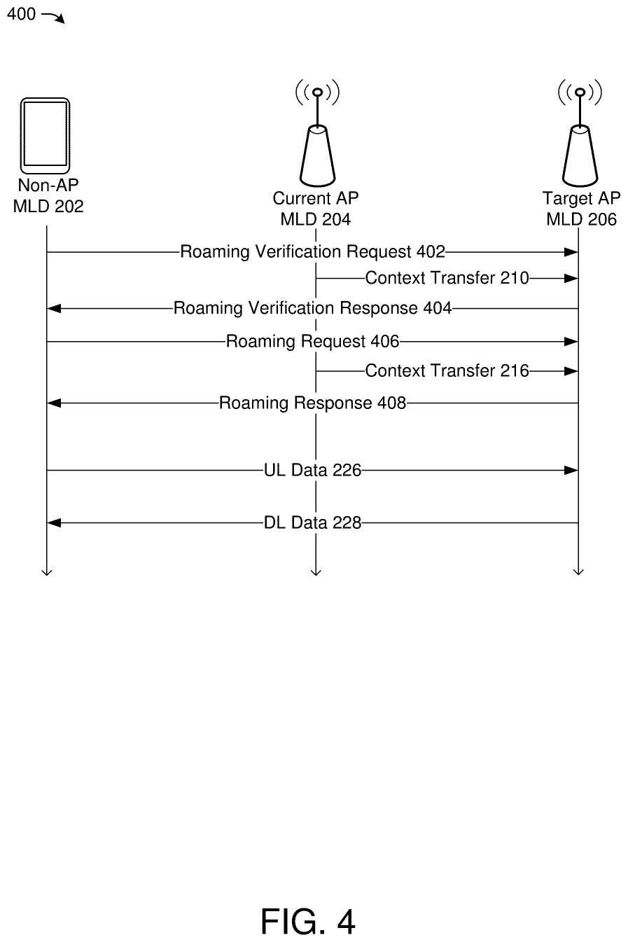

Case 2.1: non-AP MLD 202 has not done any preparation with the current AP MLD 204, with the target AP MLD 206, and a same PTK is used. Case 2.2: non-AP MLD 202 has not done any preparation with the current AP MLD 204, with the target AP MLD 206, and a different PTK is used. Cases 2.1 and 2.2 are shown in FIG. 4.

FIG. 4 is an example flow of a process 400 for enhanced roaming, in accordance with one or more example embodiments of the present disclosure.

Referring to FIG. 4, the process 400 may also involve the non-AP MLD 202, the current AP MLD 204, and the target AP MLD 206. This process introduces a verification exchange to ensure the target AP MLD 206 is prepared before the non-AP MLD 202 requests to roam, which is particularly advantageous in scenarios where the connection to the current AP MLD 204 may be unstable or already lost. The process 400 begins with the non-AP MLD 202 transmitting a Roaming Verification Request frame 402 to the target AP MLD 206. This allows the non-AP MLD 202 to proactively confirm the availability and readiness of the target AP MLD 206. Following the roaming verification request 402, the current AP MLD 204 performs a Context Transfer 210 to the target AP MLD 206, pre-loading it with the necessary parameters for the non-AP MLD 202. The target AP MLD 206 then sends a Roaming Verification Response frame 404 back to the non-AP MLD 202, confirming that it is prepared for the handoff. Once the network is ready, the non-AP MLD 202 sends a Roaming Request frame 406 (also referred to as a transition execution request frame) to the target AP MLD 206. In response, the current AP MLD 204 may perform a Context Transfer 216 to ensure the target AP MLD 206 has the most current information, such as security contexts. The target AP MLD 206 then sends a Roaming Response frame 408 (also referred to as a transition execution response frame) to the non-AP MLD 202, completing the roaming agreement. The non-AP MLD 202 then establishes its new connection by sending UL data 226 to, and/or receiving DL data 228 from, the target AP MLD 206.

In Case 2.1, the non-AP MLD 202 will first send the roaming verification request 402. The roaming verification request 402 indicates the MAC address of the current AP MLD 204 and includes an identifier that can be identifies by the current AP MLD 204.—The identifier can be PMKID.—The identifier can be an address that the non-AP MLD 202 indicates to current AP MLD 204 during connection. Target AP MLD 206 sends the identifier to the current AP MLD 204. Current AP MLD 204 fetches the PTK and replay counter of management frame and sends to target AP MLD 206. Target AP MLD 206 sends the roaming verification response to indicate readiness.

Non-AP MLD 202 sends the encrypted roaming request frame 406. The encrypted roaming request frame 406 includes: The next PN to be used by the non-AP MLD 202. It can be separated into the next PN to be used by secure control frame and the next PN to be used by data and management frame. The next PN to be used for the data and management frame can be the PN used for the roaming request frame. Link setup request using the multi-link element. Next MAC address to be used.

Target AP MLD 206 decrypts the encrypted roaming request frame 406 and does the replay check. Target AP MLD 206 fetches contexts from current AP MLD 204. Next DL PN to be used. The latest SN of each UL TID that is being forwarded up. Existing BA parameters of non-AP MLD 202 for UL and DL.

Target AP MLD 206 sends the encrypted roaming response 408 with the following information: UL BA parameters of the target AP MLD 206. New PMKID if PMKID is used before for the identifier. The latest SN of each UL TID that is being forwarded up.

In Case 2.2, non-AP MLD 202 has not done any preparation with the current AP MLD 204, with the target AP MLD 206, and a different PTK is used. The non-AP MLD will first send the roaming verification request 402. The roaming verification request 402 indicates the MAC address of the current AP MLD 204 and includes the PMKID. The roaming verification request 402 also includes the DH parameter of the non-AP MLD 202. Target AP MLD 206 sends the PMKID to the current AP MLD 204 if there is no existing identified PMK. Current AP MLD 204 fetches the PMK and sends the PMK to the target AP MLD 206. Target AP MLD 206 derives DHss based on its DH parameter and the DH parameter of the non-AP MLD 202. Target AP MLD 206 derives PTK based on the PMK and the DHss and installs the PTK. Target AP MLD 206 sends the roaming verification response 404 to indicate readiness. Non-AP MLD 202 sends the encrypted roaming request 406 with the following information: Next PN to be used by the non-AP MLD 202 when it performs a frame exchange with the target AP MLD 206. As a result, target AP MLD 206 can initialize the value of all replay counters with the value. It can be separated into the next PN to be used by secure control frame and the next PN to be used by data and management frame. It can be 0 due to usage of different PTK. Link setup request using the multi-link element. Next MAC address to be used. Target AP MLD 206 decrypts the roaming request frame 406 to authenticate. Target AP MLD 206 fetches the contexts from the current AP MLD 204 including: The latest SN of each UL TID that is being forwarded up. Target AP MLD 206 sends the roaming response frame 408 with the following information: Link setup response using the multi-link element. New PMKID to preserve privacy. UL BA parameters of the target AP MLD 206. The latest SN of each UL TID that is being forwarded up.

Referring to FIG. 1, for MLDs, the state variable expresses the relationship between the local MLD and the remote MLD. It takes on the following values:
State 1: Initial start state for MLDs that perform IEEE 802.11 authentication. Unauthenticated and unassociated.
State 2: Authenticated but unassociated.
State 3: Authenticated and associated (Pending RSNA Authentication). The IEEE 802.1X Controlled Port is blocked.
State 4: Authenticated and associated (RSNA Established or Not Required). The IEEE 802.1X Controlled Port is unblocked, or not present.

A STA shall not transmit Class 2 frames unless in State 2 or State 3 or State 4.

A STA shall not transmit Class 3 frames unless in State 3 or State 4.

Background: 11bn roaming design:

11bn has redesigned roaming to improve performance and minimize data loss. Consider that a non-AP MLD roams from current AP MLD to target AP MLD that is in a seamless mobility domain (SMD).
The DL data loss is minimized by having a transient period to continue to receive DL data from current AP MLD.
The UL data loss is minimized by having non-AP MLD to be informed by the existing forwarding up data from current AP MLD to continue the data transmission without duplicate.
The performance improvement is achieved by having parameters of existing negotiation with current AP MLD to be transferred as contexts without the need to reestablish parameters with target AP MLD.
The performance improvement is also achieved by having potential preparation frame exchange to speed up the roaming exchange.

To facilitate the definition of operation, start with the definition of the state machine between non-AP MLD, current AP MLD, and target AP MLD.

The state between non-AP MLD and SMD is state 4 to highlight the state that can be copied to AP MLD within the SMD.

After preparation request/response exchange, the state between non-AP MLD and current AP MLD is state 4 and the mapping between non-AP MLD and current AP MLD is provided to the DS.
Option 1: The state between non-AP MLD and target AP MLD is state 2.
Option 2: The state between non-AP MLD and target AP MLD is defined to be a new state 4a, which is:
   Authenticated and associated (RSNA Established or Not Required).
   The IEEE 802.1X Controlled Port is blocked.
   no class 3 frame exchange.
   Allow class 1 and class 2 frame exchange.
   The mapping between non-AP MLD and target AP MLD is not provided to the DS.

After roaming request/response exchange and in the transient period:
The state between non-AP MLD and target AP MLD is state 4 and the mapping between non-AP MLD and current AP MLD is provided to the DS.
   In power save mode of all the links setup with target AP MLD
   The requirement to listen for beacons of target AP MLD within listen interval during power save mode is suspended.
Option 1: The state between non-AP MLD and current AP MLD is state 4 with additional restriction of:
   Only DL data reception and control frame response.
   The mapping between non-AP MLD and target AP MLD is not provided to the DS.
Option 2: The state between non-AP MLD and current AP MLD is defined to be a new state 4b, which is:
   Authenticated and associated (RSNA Established or Not Required).
   The IEEE 802.1X Controlled Port is unblocked.
   No UL data transmission.
   No DL management frame transmission.
   The mapping between non-AP MLD and target AP MLD is not provided to the DS.
State 4 with transient behaviors defined to be additional restriction of only DL data reception and control frame response.

After transient period ends:
The state between non-AP MLD and current AP MLD is state 2.
The state between non-AP MLD and target AP MLD is state 4 and the mapping between non-AP MLD and target AP MLD is provided to the DS.

Continuing the definition of operations for the end of the transient period, the earliest occurrence of any of the following events will trigger the transition.

When a timeout defines for the transient period expires, the timeout value can be indicated in roaming response using the timeout interval element (TIE).

When non-AP MLD sends the transient period early termination frame to current AP MLD or target AP MLD.

Now defining the frame that can work with the proposed operation above.

For transient period early termination frame:
Define UHR protected action frame.
The action field format of the request frame is shown below in Table 1.

TABLE 1
Action Field Format of Request Frame

| Order | Meaning |
|---|---|
| 1 | Category |
| 2 | Protected UHR Action |
| 3 | Dialog Token |

Next, a roaming element is defined to indicate various pieces of information relevant to roaming.

Roaming element includes:
Roaming control field may include but not limited to the following:
   Indicate existence of next PN for data/management frame field.
   Indicate existence of next PN for control frame field.
   Indicate transfer of SN context.
   Indicate for preparation.
   Indicate for roaming.
   Indicate drop of DL data for certain TIDs.
   Indicate existence of latest SN forward up.
   Indicate existence of UL BA parameters for a TID of target AP MLD.
   Indicate existence of UL BA parameters for a TID of target AP MLD.
   Indicate existence of target AP MLD MAC address.
   Indicate existence of listen interval.
   Roaming Info field may include but not limited to the following:
   Listen interval field.
   Target AP MLD MAC address.
   Next PN for data/management frame field.
   Next PN for control frame in any link field.
   8 latest SN forward up fields in order of TIDs from 0 to 7.
   8 UL BA parameters in order of TIDs from 0 to 7:
      Block Ack Parameter Set field value as defined in 9.4.1.13 (Block Ack Parameter Set field).
      Block Ack Timeout Value field value as defined in 9.4.1.14 (Block Ack Timeout Value field).
         Block Ack Starting Sequence Control subfield value as defined in 9.3.1.7 (BlockAckReq frame format).
   8 DL BA parameters in order of TIDs from 0 to 7:
      Block Ack Parameter Set field value as defined in 9.4.1.13 (Block Ack Parameter Set field).
      Block Ack Timeout Value field value as defined in 9.4.1.14 (Block Ack Timeout Value field).
         Block Ack Starting Sequence Control subfield value as defined in 9.3.1.7 (BlockAckReq frame format).
   DL TID bitmap field that indicates which TID of DL data to be dropped.

For preparation request/response:
Option 1: define UHR protected action frame.

Two action frames are defined:
Preparation request frame.
Preparation response frame.

The action field format of the request frame is shown in Table 2 below:

TABLE 2
Action Field Format of Request Frame

| Order | Meaning |
|---|---|
| 1 | Category |
| 2 | Protected UHR Action |
| 3 | Dialog Token |
| 5 | Listen Interval |
| 6 | Target AP MLD MAC address |
| 7 | Basic Multi-link element |
| 8 | Diffie-Hellman Parameter element |
| 9 | Roaming element |

The listen interval field is the same as the listen interval field in the reassociation request frame.

The basic multi-link element includes the per STA profile for the setup link from non-AP MLD in the request frame, carries fields and elements in the same order and subject to the conditions as if the frame is a Reassociation request frame except the listen interval field.

Diffie-Hellman Parameter element is as defined in the current specification.

Roaming element is as defined above. The action field format of the response frame is shown in Table 3 below:

TABLE 3
Action Field Format of Response Frame

| Order | Meaning |
|---|---|
| 1 | Category |
| 2 | Protected UHR Action |
| 3 | Dialog Token |
| 4 | Basic Multi-link element |
| 5 | Diffie-Hellman Parameter element |
| 6 | Roaming element |

The basic multi-link element includes the per STA profile for the setup link from target AP MLD in the response frame, carries fields and elements in the same order and subject to the conditions as if the frame is a Reassociation Response frame.

Diffie-Hellman Parameter element is as defined in the current specification.

Roaming element is as defined above.
Option 2: reuse link reconfiguration request/response:
   Only add link operation is allowed in link reconfiguration request frame.
   No Target AP MLD delete link and no non-AP MLD reconfiguring links of target AP MLD before the end of transient period.
      Include Roaming element in link reconfiguration request frame and link reconfiguration response frame.
   Indicate the link reconfiguration request is for preparation request. The indication can be in:
   Roaming element.
   Reconfiguration Multi-Link element. One bit in Presence Bitmap subfield format of the Reconfiguration Multi-Link element to indicate existence of field in Common Info field.

Include Listen interval in link reconfiguration request frame. The indication can be in:
Roaming element.
Reconfiguration Multi-Link element. One bit in Presence Bitmap subfield format of the Reconfiguration Multi-Link element to indicate existence of field in Common Info field.

Include Target AP MLD MAC address in link reconfiguration request frame. The indication can be in:
Roaming element.
Reconfiguration Multi-Link element. One bit in Presence Bitmap subfield format of the Reconfiguration Multi-Link element to indicate existence of field in Common Info field.

For roaming request/response:
Option 1: define UHR protected action frame.

Two action frames are defined:
Roaming request frame.
Roaming response frame.

The action field format of the request frame is shown in Table 4 below:

TABLE 4
Action Field Format of Request Frame

| Order | Meaning |
|---|---|
| 1 | Category |
| 2 | Protected UHR Action |
| 3 | Dialog Token |
| 5 | Listen Interval |
| 6 | Target AP MLD MAC address |
| 7 | Basic Multi-link element |
| 8 | Diffie-Hellman Parameter element |
| 9 | Roaming element |

The listen interval field is the same as the listen interval field in the reassociation request frame.

The basic multi-link element includes the per STA profile for the setup link from non-AP MLD in the request frame, carries fields and elements in the same order and subject to the conditions as if the frame is a Reassociation request frame except the listen interval field.

Diffie-Hellman Parameter element is as defined in the current specification.

Roaming element is as defined above.

The action field format of the response frame is shown in Table 5 below:

TABLE 5
Action Field Format of Response Frame

| Order | Meaning |
|---|---|
| 1 | Category |
| 2 | Protected UHR Action |
| 3 | Dialog Token |
| 4 | Basic Multi-link element |
| 5 | Diffie-Hellman Parameter element |
| 6 | Roaming element |

The basic multi-link element includes the per STA profile for the setup link from target AP MLD in the response frame, carries fields and elements in the same order and subject to the conditions as if the frame is a Reassociation Response frame.

Diffie-Hellman Parameter element is as defined in the current specification.

Roaming element is as defined above.
Option 2: reuse link reconfiguration request/response.

Only add link operation is allowed in link reconfiguration request frame no Target AP MLD delete link and no non-AP MLD reconfiguring links of target AP MLD before the end of transient period.

Include Roaming element in link reconfiguration request frame and link reconfiguration response frame.

Indicate the link reconfiguration request is for roaming request. The indication can be in:
Roaming element.
Reconfiguration Multi-Link element. One bit in Presence Bitmap subfield format of the Reconfiguration Multi-Link element to indicate existence of field in Common Info field.

Include Listen interval in link reconfiguration request frame. The indication can be in:
Roaming element.
Reconfiguration Multi-Link element. One bit in Presence Bitmap subfield format of the Reconfiguration Multi-Link element to indicate existence of field in Common Info field.

Include Target AP MLD MAC address in link reconfiguration request frame. The indication can be in:
Roaming element.
Reconfiguration Multi-Link element. One bit in Presence Bitmap subfield format of the Reconfiguration Multi-Link element to indicate existence of field in Common Info field.

UHR Link Reconfiguration response frame is proposed to serve the purpose of preparation response or execution response. The current format of UHR Link Reconfiguration Response frame is shown below in Table 6. It is an action frame, so it has an action field, and the action field format follows the 802.11be Link Reconfiguration response frame design.

TABLE 6
Action Frame Body and Action No Ack Frame Body

| Order | Information |
|---|---|
| 1 | Action |
| Last - 4 (#11be) | The MLO Link Info element is present as defined in 35.3.14.3 (Identification |
| | of the intended STA). Otherwise, not present. |
| Last - 3 | One or more Vendor Specific elements are optionally present. These |
| | elements are absent when the Category subfield of the Action field is |
| | Vendor-Specific, Vendor-Specific Protected, or when the Category subfield |
| | of the Action field is VHT and the VHT Action subfield of the Action field |
| | is VHT Compressed Beamforming, or when the Category subfield of the |
| | Action field is HE and the HE Action subfield of the Action field is HE |
| | Compressed Beamforming/CQI(#11be), or when the Category subfield of |
| | the Action field is EHT and the EHT Action subfield of the Action field is |
| | EHT Compressed Beamforming/CQI. |
| Last - 2 | The MME is present when management frame protection is enabled at the |
| | AP and the frame is a group addressed robust Action or Action No Ack |
| | frame not of a category specified with Yes in the group addressed privacy |
| | column of Table 9-93 (Category values); otherwise not present. |
| Last - 1 | The MIC element is present in a Self-protected Action frame if a shared |
| | PMK exists between the sender and recipient of this frame; otherwise not |
| | present. |
| Last | The Authenticated Mesh Peering Exchange element is present in a Self- |
| | protected Action frame if a shared PMK exists between the sender and |
| | recipient of this frame; otherwise not present. |

Table 6 above shows an example format for an Action frame body and an Action No Ack frame body. As shown, the frame body may be structured to include an Action field as its first element. The frame body may further comprise a plurality of subsequent elements, where the inclusion of each element may be conditional upon certain criteria. For instance, an MLO Link Info element may be present for identification of an intended station (STA). One or more Vendor Specific elements may be optionally present, but may be absent when, for example, a Category subfield of the Action field is associated with Vendor-Specific, VHT Compressed Beamforming, HE Compressed Beamforming/CQI, or EHT Compressed Beamforming/CQI frames. A Management Message Element (MME) may be present in cases where management frame protection is enabled at an access point (AP) and the frame is a group addressed robust Action or Action No Ack frame of a specific category. Furthermore, a Message Integrity Code (MIC) element and an Authenticated Mesh Peering Exchange element may be present in a Self-protected Action frame, for example, if a shared Pairwise Master Key (PMK) exists between the sender and recipient of the frame.

TABLE 7
UHR Link Reconfiguration Response Frame Action Field Format

| Order | Meaning |
|---|---|
| 1 | Category |
| 2 | Protected UHR Action |
| 3 | Dialog Token |
| 4 | Type |
| 5 | Count |
| 6 | Reconfiguration Status List |
| 7 | Group Key Data (optional) |
| 8 | OCI element (see 9.4.2.235 (OCI element)) (optional) |
| 9 | Basic Multi-Link element (see 9.4.2.322.2 (Basic Multi-Link element)) |
| | (optional) |
| 10 | SMD BSS Transition Parameters element (see 9.4.2.aa5 (SMD BSS |
| | Transition Parameters element(#2023))) (optional) |
| 11 | MSCS Descriptor element as defined in the (Re)Association Response (see |
| | 9.4.2.242 (MSCS Descriptor element)) (optional) |
| 12 | Diffie-Hellman element (see 9.4.2.312 (Diffie-Hellman Parameter element)) |
| | (optional) |
| 13 | Nonce element (see 9.4.2.188 (Nonce element)) (optional) |

Table 7 shows an example format for a UHR Link Reconfiguration Response frame Action field. As illustrated, the Action field may be structured to include a sequence of elements, beginning with a Category field, a Protected UHR Action field, a Dialog Token field, a Type field, a Count field, and a Reconfiguration Status List field. The Action field may further comprise one or more optional fields. For example, a Group Key Data field may be optionally present. Other optional fields may include an OCI element, a Basic Multi-Link element, an SMD BSS Transition Parameters element, an MSCS Descriptor element, a Diffie-Hellman element, and/or a Nonce element.

Table 8 shows a format of the Group Key Data.

TABLE 8
Group Key Data Format

| | |
|---|---|
| Key Data Length (1 octet) | Key Data (variable octets) |

The Key Data includes multiple KDEs. The KDE format is shown in Table 9 below with 6 bytes header:

TABLE 9
KDE Format

| | | | | |
|---|---|---|---|---|
| Type (0xdd) | Length | OUI | Data Type | Data (Length- |
| (1 octet) | (1 octet) | (3 octets) | (1 octet) | 4 octets) |

Examples include MLO GTK/IGTK/BIGTK KDE.

MLO GTK has 7 bytes+key as shown in Table 10 below:

TABLE 10
MLO GTK KDE Format

| | | | | | |
|---|---|---|---|---|---|
| Key ID | Tx | Reserved | Link ID | PN | GTK |
| (2 bits) | (1 bit) | (1 bit) | (4 bits) | (48 bits) | (variable |
| | | | | | bits) |

MLO IGTK has 9 bytes+key as shown below in Table 11:

TABLE 11
MLO IGTK KDE Format

| | | | | |
|---|---|---|---|---|
| Key ID | IPN | Reserved | Link ID | IGTK (Length- |
| (16 bits) | (48 bits) | (4 bit) | (4 bits) | 13 × 8 bits) |

MLO BIGTK has 9 bytes+key as shown below in Table 12:

TABLE 12
MLO BIGTK KDE Format

| | | | | |
|---|---|---|---|---|
| Key ID | BIPN | Reserved | Link ID | BIGTK (Length- |
| (16 bits) | (48 bits) | (4 bit) | (4 bits) | 13 × 8 bits) |

For the Group Key Data field, the Key Data length can only indicate at most 255 bytes as shown below in Table 13:

TABLE 13
Key Data Lengths

| | 128 bit | 256 bit |
|---|---|---|
| MLO GTK | 13 + 16 = 29 | 13 + 32 = 45 |
| MLO IGTK | 15 + 16 = 31 | 15 + 32 = 47 |
| MLO BIGTK | 15 + 16 = 31 | 15 + 32 = 47 |
| Total | 91 | 139 |

However, if the size is counted, it can be seen that only keys for two links under 128 bit and keys for one link under 256 bits can fit in. For UHR Link Reconfiguration Response that is used for link preparation with a target AP MLD, the number of links is common to be 3, and the use case is then not supported.

Another issue is that Basic multi-link elements are used to include all the information of target AP MLD. However, currently there is no element inheritance defined for UHR Link Reconfiguration Response or Link Reconfiguration Response defined in EHT.

There is no previous solution for UHR Link Reconfiguration Request.

It is proposed that in UHR Link Reconfiguration Response frame:

Key Delivery element is included to include group key KDE:
Tthe RSC field set to 0.
With the MLO GTK KDE for each setup link.
With the MLO IGTK KDE for each setup link if management frame protection is negotiated, with the MLO.
BIGTK KDE for each setup link if beacon protection is enabled.
CIGTK KDE for each setup link if control frame protection is negotiated.
With the PGTK KDE if the Group EPP Epoch Supported field in the RSNXE is set to 1 by both the APs affiliated with the AP MLD and the non-AP MLD.

Key Delivery element can replace Group Key Data field.

Key Delivery element can be before or after Basic Multi-link element.

Key Delivery element can provide additional Group key information if there is a Group Key Data field.

The following is proposed for the inheritance rule in the UHR Link Reconfiguration Response frame:

Except for the Vendor Specific element, if an element, identified by an Element ID and Element ID Extension (if applicable), is carried in the first per STA profile subelement in the Basic Multi-Link element and there is no element having the same Element ID and Element ID Extension (if applicable) in a complete profile of a following per STA profile subelement in the same Basic Multi-Link element, then the element is inherited and is considered to be part of the following per STA profile subelement and the value of the element to use in the following per STA profile subelement is the same as that of the corresponding element carried in the first per STA profile subelement unless the following per STA profile subelement carries the Non-Inheritance element (see 9.4.2.239 (Non-Inheritance element)) and the element is listed in that Non-Inheritance element.

For Vendor Specific element:
The Vendor Specific elements are not inherited in any per STA profile subelement in the Basic Multi-Link element. If there is a Vendor Specific element that is required to be part of a per STA profile subelement in the Basic Multi-Link element of the EPP Capabilities and Operation Parameters Response frame, the Vendor Specific element is included in that per STA profile subelement.
Follow the same rule in first bullet.

The following is proposed for the Link Reconfiguration Response frame defined in EHT.

Include Key Delivery element to indicate additional group keys:
The RSC field set to 0.
With the MLO GTK KDE for each setup link that is not included in the Group Key Data field.
With the MLO IGTK KDE for each setup link that is not included in the Group Key Data field if management frame protection is negotiated.
With the MLO BIGTK KDE for each setup link that is not included in the Group Key Data field if beacon protection is enabled.
CIGTK KDE for each setup link that is not included in the Group Key Data field if control frame protection is negotiated.
With the PGTK KDE that is not included in the Group Key Data field if the Group EPP Epoch Supported field in the RSNXE is set to 1 by both the APs affiliated with the AP MLD and the non-AP MLD.

It is understood that the above descriptions are for the purposes of illustration and are not meant to be limiting.

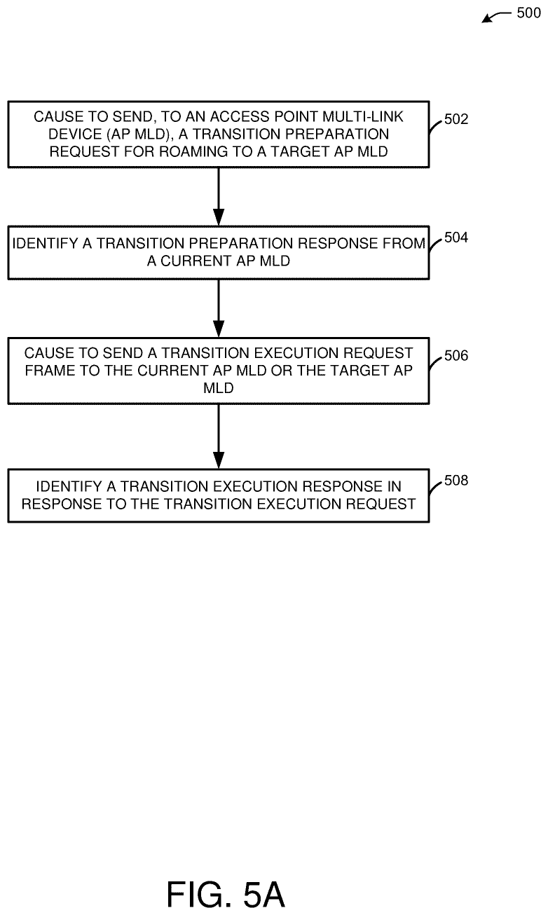

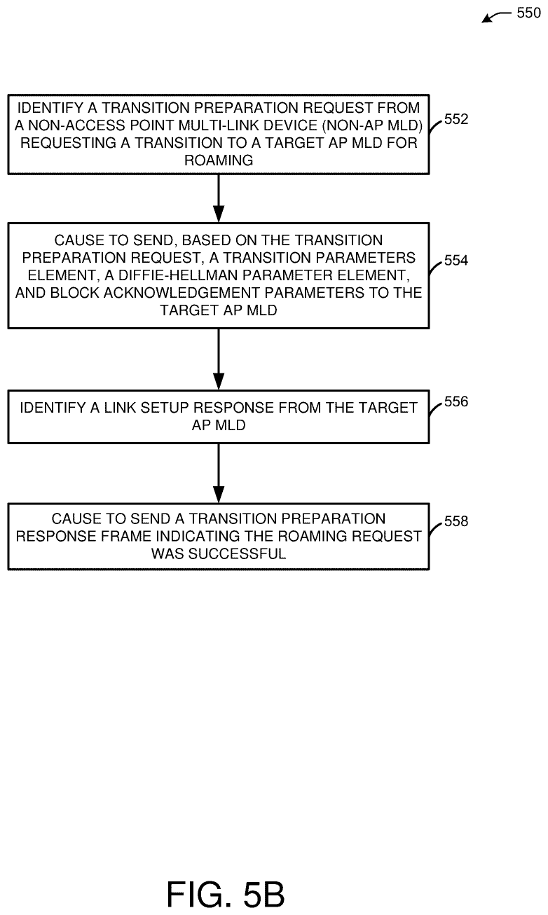

FIG. 5A illustrates a flow diagram of illustrative process 500 for an enhanced roaming system, in accordance with one or more example embodiments of the present disclosure.

At block 502, a device (e.g., the user device(s) 120 of FIG. 1, the non-AP MLD 202 of FIG. 2, and/or the enhanced roaming device 719 of FIG. 7) may send, to an access point MLD (AP MLD), such as current AP MLD 204, a transition preparation request frame indicating a request of a multi-link device (MLD), such as non-AP MLD 202, to transition to a single target AP MLD, such as target AP MLD 206. The transition preparation request frame may be a protected ultra high reliability (UHR) action frame including an indication that the UHR action frame may be for transition preparation. The frame may include a reconfiguration multilink element signaling a medium access control (MAC) address of target AP MLD 206, a seamless mobility domain basic service set (BSS) transition parameters element signaling a listen interval for target AP MLD 206, and a Diffie-Hellman parameter element signaling a Diffie-Hellman parameter associated with deriving a Diffie-Hellman secret to be used by target AP MLD 206 to generate a new pairwise transient key (PTK). The transition preparation request frame may further include an indication of a next packet number to be used by uplink data. In some examples, the seamless mobility domain BSS transition parameters element may include an indication of a transfer of sequence number context, an existence of downlink block acknowledgement parameters for a traffic identifier of target AP MLD 206, and an existence of uplink parameters for a traffic identifier of target AP MLD 206. The seamless mobility domain BSS transition parameters element may also include latest sequence number forward up fields in order of traffic indicators 0-7, uplink block acknowledgment parameters in order of traffic indicators 0-7, including a first block acknowledgement parameter set field, a first block acknowledgement timeout value field, and a first block acknowledgement starting sequence control subfield, and downlink block acknowledgment parameters in order of traffic identifiers 0-7, including a second block acknowledgement parameter set field, a second block acknowledgment timeout value field, and a second block acknowledgement starting sequence control subfield. Context associated with the transition preparation request frame may be transferred from current AP MLD 204 to target AP MLD 206, where the context may include a current PTK if the same PTK may be used, the Diffie-Hellman Parameter of non-AP MLD 202, a next packet number to be used by target AP MLD 206, and existing BA parameters of non-AP MLD 202 for uplink and downlink transmissions.

At block 504, the device may identify a transition preparation response frame, received from current AP MLD 204, indicating that the request was successful. The transition preparation response frame may be a protected UHR action frame and may include the seamless mobility domain BSS transition parameters element and the Diffie-Hellman parameter element. In some implementations, the transition preparation response frame may include a key delivery element including a receive sequence counter field set to zero and a key data encryption (KDE) for each group key of each setup link.

At block 506, the device may send a transition execution request frame to current AP MLD 204 or target AP MLD 206. This may occur during a timeout period following the transition preparation response frame. The system may identify a seamless mobility domain information element received from current AP MLD 204 that signals the timeout period. The transition execution request frame may be a protected UHR action frame.

At block 508, the device may identify a transition execution response frame received in response to the transition execution request frame. The transition execution response frame may be a protected UHR action frame. The transition execution response frame may indicate a latest sequence number that may be forwarded up to a next medium access control (MAC) layer processing for each uplink traffic identifier in the seamless mobility domain BSS transition parameters element. The system may be further configured to cause to send uplink data to target AP MLD 206 based on the indication of the latest sequence number. The system may also cause to send an early termination frame to terminate a time period after receiving the transition execution response frame to receive downlink data from current AP MLD 204.

FIG. 5B illustrates a flow diagram of illustrative process 550 for an enhanced roaming system, in accordance with one or more example embodiments of the present disclosure.

At block 552, a device (e.g., the AP(s) 102 of FIG. 1, the current AP MLD 204 of FIG. 2, and/or the enhanced roaming device 719 of FIG. 7) may identify a transition preparation request frame received from a non-AP multi-link device (MLD), such as non-AP MLD 202, indicating a request of non-AP MLD 202 to transition from the AP MLD, such as current AP MLD 204, to a single target AP MLD, such as target AP MLD 206. The transition preparation request frame may include a reconfiguration multilink element signaling a medium access control (MAC) address of target AP MLD 206, a seamless mobility domain basic service set (BSS) transition parameters element signaling a listen interval for target AP MLD 206, and a Diffie-Hellman parameter element signaling a Diffie-Hellman parameter associated with deriving a Diffie-Hellman secret to be used by target AP MLD 206 to generate a new pairwise transient key (PTK). The transition preparation request frame may further include an indication of a next packet number to be used by uplink data. The seamless mobility domain BSS transition parameters element may include an indication of a transfer of sequence number context, an existence of downlink block acknowledgement parameters for a traffic identifier of target AP MLD 206, and an existence of uplink parameters for a traffic identifier of target AP MLD 206. The seamless mobility domain BSS transition parameters element may also include latest sequence number forward up fields in order of traffic indicators 0-7, uplink block acknowledgment parameters in order of traffic indicators 0-7, including a first block acknowledgement parameter set field, a first block acknowledgement timeout value field, and a first block acknowledgment starting sequence control subfield, and downlink block acknowledgment parameters in order of traffic identifiers 0-7, including a second block acknowledgement parameter set field, a second block acknowledgment timeout value field, and a second block acknowledgement starting sequence control subfield.

At block 554, the device may send, based on the transition preparation request frame to transition to target AP MLD 206, the seamless mobility domain BSS transition parameters element, the Diffie-Hellman parameter element, and block acknowledgment parameters of the target AP MLD. This operation may be part of a context transfer, such as Context Transfer 210, from current AP MLD 204 to target AP MLD 206.

At block 556, the device may identify a link setup response using a multi-link element of target AP MLD 206, where the link setup response may be received from target AP MLD 206.

At block 558, the device may send a transition preparation response frame to non-AP MLD 202 and indicating that the request was successful. The system may also cause to send a seamless mobility domain information element to non-AP MLD 202 that signals a timeout period.

It is understood that the above descriptions are for the purposes of illustration and are not meant to be limiting.

FIG. 6 shows a functional diagram of an exemplary communication station 600, in accordance with one or more example embodiments of the present disclosure. In one embodiment, FIG. 6 illustrates a functional block diagram of a communication station that may be suitable for use as an AP 102 (FIG. 1) or a user device 120 (FIG. 1) in accordance with some embodiments. The communication station 600 may also be suitable for use as a handheld device, a mobile device, a cellular telephone, a smartphone, a tablet, a netbook, a wireless terminal, a laptop computer, a wearable computer device, a femtocell, a high data rate (HDR) subscriber station, an access point, an access terminal, or other personal communication system (PCS) device.

The communication station 600 may include communications circuitry 602 and a transceiver 610 for transmitting and receiving signals to and from other communication stations using one or more antennas 601. The communications circuitry 602 may include circuitry that can operate the physical layer (PHY) communications and/or medium access control (MAC) communications for controlling access to the wireless medium, and/or any other communications layers for transmitting and receiving signals. The communication station 600 may also include processing circuitry 606 and memory 608 arranged to perform the operations described herein. In some embodiments, the communications circuitry 602 and the processing circuitry 606 may be configured to perform operations detailed in the above figures, diagrams, and flows.

In accordance with some embodiments, the communications circuitry 602 may be arranged to contend for a wireless medium and configure frames or packets for communicating over the wireless medium. The communications circuitry 602 may be arranged to transmit and receive signals. The communications circuitry 602 may also include circuitry for modulation/demodulation, upconversion/downconversion, filtering, amplification, etc. In some embodiments, the processing circuitry 606 of the communication station 600 may include one or more processors. In other embodiments, two or more antennas 601 may be coupled to the communications circuitry 602 arranged for sending and receiving signals. The memory 608 may store information for configuring the processing circuitry 606 to perform operations for configuring and transmitting message frames and performing the various operations described herein. The memory 608 may include any type of memory, including non-transitory memory, for storing information in a form readable by a machine (e.g., a computer). For example, the memory 608 may include a computer-readable storage device, read-only memory (ROM), random-access memory (RAM), magnetic disk storage media, optical storage media, flash-memory devices and other storage devices and media.

In some embodiments, the communication station 600 may be part of a portable wireless communication device, such as a personal digital assistant (PDA), a laptop or portable computer with wireless communication capability, a web tablet, a wireless telephone, a smartphone, a wireless headset, a pager, an instant messaging device, a digital camera, an access point, a television, a medical device (e.g., a heart rate monitor, a blood pressure monitor, etc.), a wearable computer device, or another device that may receive and/or transmit information wirelessly.

In some embodiments, the communication station 600 may include one or more antennas 601. The antennas 601 may include one or more directional or omnidirectional antennas, including, for example, dipole antennas, monopole antennas, patch antennas, loop antennas, microstrip antennas, or other types of antennas suitable for transmission of RF signals. In some embodiments, instead of two or more antennas, a single antenna with multiple apertures may be used. In these embodiments, each aperture may be considered a separate antenna. In some multiple-input multiple-output (MIMO) embodiments, the antennas may be effectively separated for spatial diversity and the different channel characteristics that may result between each of the antennas and the antennas of a transmitting station.

In some embodiments, the communication station 600 may include one or more of a keyboard, a display, a non-volatile memory port, multiple antennas, a graphics processor, an application processor, speakers, and other mobile device elements. The display may be an LCD screen including a touch screen.

Although the communication station 600 is illustrated as having several separate functional elements, two or more of the functional elements may be combined and may be implemented by combinations of software-configured elements, such as processing elements including digital signal processors (DSPs), and/or other hardware elements. For example, some elements may include one or more microprocessors, DSPs, field-programmable gate arrays (FPGAs), application specific integrated circuits (ASICs), radio-frequency integrated circuits (RFICs) and combinations of various hardware and logic circuitry for performing at least the functions described herein. In some embodiments, the functional elements of the communication station 600 may refer to one or more processes operating on one or more processing elements.

Certain embodiments may be implemented in one or a combination of hardware, firmware, and software. Other embodiments may also be implemented as instructions stored on a computer-readable storage device, which may be read and executed by at least one processor to perform the operations described herein. A computer-readable storage device may include any non-transitory memory mechanism for storing information in a form readable by a machine (e.g., a computer). For example, a computer-readable storage device may include read-only memory (ROM), random-access memory (RAM), magnetic disk storage media, optical storage media, flash-memory devices, and other storage devices and media. In some embodiments, the communication station 600 may include one or more processors and may be configured with instructions stored on a computer-readable storage device.

FIG. 7 illustrates a block diagram of an example of a machine 700 or system upon which any one or more of the techniques (e.g., methodologies) discussed herein may be performed. In other embodiments, the machine 700 may operate as a standalone device or may be connected (e.g., networked) to other machines. In a networked deployment, the machine 700 may operate in the capacity of a server machine, a client machine, or both in server-client network environments. In an example, the machine 700 may act as a peer machine in peer-to-peer (P2P) (or other distributed) network environments. The machine 700 may be a personal computer (PC), a tablet PC, a set-top box (STB), a personal digital assistant (PDA), a mobile telephone, a wearable computer device, a web appliance, a network router, a switch or bridge, or any machine capable of executing instructions (sequential or otherwise) that specify actions to be taken by that machine, such as a base station. Further, while only a single machine is illustrated, the term “machine” shall also be taken to include any collection of machines that individually or jointly execute a set (or multiple sets) of instructions to perform any one or more of the methodologies discussed herein, such as cloud computing, software as a service (SaaS), or other computer cluster configurations.

Examples, as described herein, may include or may operate on logic or a number of components, modules, or mechanisms. Modules are tangible entities (e.g., hardware) capable of performing specified operations when operating. A module includes hardware. In an example, the hardware may be specifically configured to carry out a specific operation (e.g., hardwired). In another example, the hardware may include configurable execution units (e.g., transistors, circuits, etc.) and a computer readable medium containing instructions where the instructions configure the execution units to carry out a specific operation when in operation. The configuring may occur under the direction of the executions units or a loading mechanism. Accordingly, the execution units are communicatively coupled to the computer-readable medium when the device is operating. In this example, the execution units may be a member of more than one module. For example, under operation, the execution units may be configured by a first set of instructions to implement a first module at one point in time and reconfigured by a second set of instructions to implement a second module at a second point in time.

The machine (e.g., computer system) 700 may include a hardware processor 702 (e.g., a central processing unit (CPU), a graphics processing unit (GPU), a hardware processor core, or any combination thereof), a main memory 704 and a static memory 706, some or all of which may communicate with each other via an interlink (e.g., bus) 708. The machine 700 may further include a power management device 732, a graphics display device 710, an alphanumeric input device 712 (e.g., a keyboard), and a user interface (UI) navigation device 714 (e.g., a mouse). In an example, the graphics display device 710, alphanumeric input device 712, and UI navigation device 714 may be a touch screen display. The machine 700 may additionally include a storage device (i.e., drive unit) 716, a signal generation device 718 (e.g., a speaker), an enhanced roaming device 719, a network interface device/transceiver 720 coupled to antenna(s) 730, and one or more sensors 728, such as a global positioning system (GPS) sensor, a compass, an accelerometer, or other sensor. The machine 700 may include an output controller 734, such as a serial (e.g., universal serial bus (USB), parallel, or other wired or wireless (e.g., infrared (IR), near field communication (NFC), etc.) connection to communicate with or control one or more peripheral devices (e.g., a printer, a card reader, etc.)). The operations in accordance with one or more example embodiments of the present disclosure may be carried out by a baseband processor. The baseband processor may be configured to generate corresponding baseband signals. The baseband processor may further include physical layer (PHY) and medium access control layer (MAC) circuitry, and may further interface with the hardware processor 702 for generation and processing of the baseband signals and for controlling operations of the main memory 704, the storage device 716, and/or the enhanced roaming device 719. The baseband processor may be provided on a single radio card, a single chip, or an integrated circuit (IC).

The storage device 716 may include a machine readable medium 722 on which is stored one or more sets of data structures or instructions 724 (e.g., software) embodying or utilized by any one or more of the techniques or functions described herein. The instructions 724 may also reside, completely or at least partially, within the main memory 704, within the static memory 706, or within the hardware processor 702 during execution thereof by the machine 700. In an example, one or any combination of the hardware processor 702, the main memory 704, the static memory 706, or the storage device 716 may constitute machine-readable media.

The enhanced roaming device 719 may carry out or perform any of the operations and processes (e.g., processes 500 and 550) described and shown above.

It is understood that the above are only a subset of what the enhanced roaming device 719 may be configured to perform and that other functions included throughout this disclosure may also be performed by the enhanced roaming device 719.

While the machine-readable medium 722 is illustrated as a single medium, the term “machine-readable medium” may include a single medium or multiple media (e.g., a centralized or distributed database, and/or associated caches and servers) configured to store the one or more instructions 724.

Various embodiments may be implemented fully or partially in software and/or firmware. This software and/or firmware may take the form of instructions contained in or on a non-transitory computer-readable storage medium. Those instructions may then be read and executed by one or more processors to enable performance of the operations described herein. The instructions may be in any suitable form, such as but not limited to source code, compiled code, interpreted code, executable code, static code, dynamic code, and the like. Such a computer-readable medium may include any tangible non-transitory medium for storing information in a form readable by one or more computers, such as but not limited to read only memory (ROM); random access memory (RAM); magnetic disk storage media; optical storage media; a flash memory, etc.

The term “machine-readable medium” may include any medium that is capable of storing, encoding, or carrying instructions for execution by the machine 700 and that cause the machine 700 to perform any one or more of the techniques of the present disclosure, or that is capable of storing, encoding, or carrying data structures used by or associated with such instructions. Non-limiting machine-readable medium examples may include solid-state memories and optical and magnetic media. In an example, a massed machine-readable medium includes a machine-readable medium with a plurality of particles having resting mass. Specific examples of massed machine-readable media may include non-volatile memory, such as semiconductor memory devices (e.g., electrically programmable read-only memory (EPROM), or electrically erasable programmable read-only memory (EEPROM)) and flash memory devices; magnetic disks, such as internal hard disks and removable disks; magneto-optical disks; and CD-ROM and DVD-ROM disks.

The instructions 724 may further be transmitted or received over a communications network 726 using a transmission medium via the network interface device/transceiver 720 utilizing any one of a number of transfer protocols (e.g., frame relay, internet protocol (IP), transmission control protocol (TCP), user datagram protocol (UDP), hypertext transfer protocol (HTTP), etc.). Example communications networks may include a local area network (LAN), a wide area network (WAN), a packet data network (e.g., the Internet), mobile telephone networks (e.g., cellular networks), plain old telephone (POTS) networks, wireless data networks (e.g., Institute of Electrical and Electronics Engineers (IEEE) 802.11 family of standards known as Wi-Fi®, IEEE 802.16 family of standards known as WiMax®), IEEE 802.15.4 family of standards, and peer-to-peer (P2P) networks, among others. In an example, the network interface device/transceiver 720 may include one or more physical jacks (e.g., Ethernet, coaxial, or phone jacks) or one or more antennas to connect to the communications network 726. In an example, the network interface device/transceiver 720 may include a plurality of antennas to wirelessly communicate using at least one of single-input multiple-output (SIMO), multiple-input multiple-output (MIMO), or multiple-input single-output (MISO) techniques. The term “transmission medium” shall be taken to include any intangible medium that is capable of storing, encoding, or carrying instructions for execution by the machine 700 and includes digital or analog communications signals or other intangible media to facilitate communication of such software.

The operations and processes described and shown above may be carried out or performed in any suitable order as desired in various implementations. Additionally, in certain implementations, at least a portion of the operations may be carried out in parallel. Furthermore, in certain implementations, less than or more than the operations described may be performed.

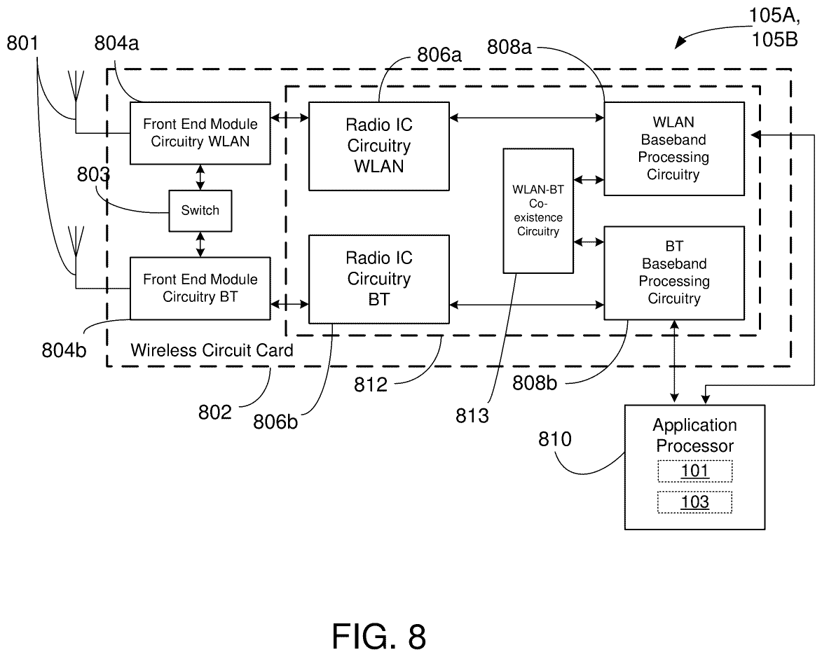

FIG. 8 is a block diagram of a radio architecture 105A, 105B in accordance with some embodiments that may be implemented in any one of the example APs 102 and/or the example STAs 120 of FIG. 1. Radio architecture 105A, 105B may include radio front-end module (FEM) circuitry 804a-b, radio IC circuitry 806a-b and baseband processing circuitry 808a-b. Radio architecture 105A, 105B as shown includes both Wireless Local Area Network (WLAN) functionality and Bluetooth (BT) functionality although embodiments are not so limited. In this disclosure, “WLAN” and “Wi-Fi” are used interchangeably.

FEM circuitry 804a-b may include a WLAN or Wi-Fi FEM circuitry 804a and a Bluetooth (BT) FEM circuitry 804b. The WLAN FEM circuitry 804a may include a receive signal path comprising circuitry configured to operate on WLAN RF signals received from one or more antennas 801, to amplify the received signals and to provide the amplified versions of the received signals to the WLAN radio IC circuitry 806a for further processing. The BT FEM circuitry 804b may include a receive signal path which may include circuitry configured to operate on BT RF signals received from one or more antennas 801, to amplify the received signals and to provide the amplified versions of the received signals to the BT radio IC circuitry 806b for further processing. FEM circuitry 804a may also include a transmit signal path which may include circuitry configured to amplify WLAN signals provided by the radio IC circuitry 806a for wireless transmission by one or more of the antennas 801. In addition, FEM circuitry 804b may also include a transmit signal path which may include circuitry configured to amplify BT signals provided by the radio IC circuitry 806b for wireless transmission by the one or more antennas. In the embodiment of FIG. 8, although FEM 804a and FEM 804b are shown as being distinct from one another, embodiments are not so limited, and include within their scope the use of an FEM (not shown) that includes a transmit path and/or a receive path for both WLAN and BT signals, or the use of one or more FEM circuitries where at least some of the FEM circuitries share transmit and/or receive signal paths for both WLAN and BT signals.

Radio IC circuitry 806a-b as shown may include WLAN radio IC circuitry 806a and BT radio IC circuitry 806b. The WLAN radio IC circuitry 806a may include a receive signal path which may include circuitry to down-convert WLAN RF signals received from the FEM circuitry 804a and provide baseband signals to WLAN baseband processing circuitry 808a. BT radio IC circuitry 806b may in turn include a receive signal path which may include circuitry to down-convert BT RF signals received from the FEM circuitry 804b and provide baseband signals to BT baseband processing circuitry 808b. WLAN radio IC circuitry 806a may also include a transmit signal path which may include circuitry to up-convert WLAN baseband signals provided by the WLAN baseband processing circuitry 808a and provide WLAN RF output signals to the FEM circuitry 804a for subsequent wireless transmission by the one or more antennas 801. BT radio IC circuitry 806b may also include a transmit signal path which may include circuitry to up-convert BT baseband signals provided by the BT baseband processing circuitry 808b and provide BT RF output signals to the FEM circuitry 804b for subsequent wireless transmission by the one or more antennas 801. In the embodiment of FIG. 8, although radio IC circuitries 806a and 806b are shown as being distinct from one another, embodiments are not so limited, and include within their scope the use of a radio IC circuitry (not shown) that includes a transmit signal path and/or a receive signal path for both WLAN and BT signals, or the use of one or more radio IC circuitries where at least some of the radio IC circuitries share transmit and/or receive signal paths for both WLAN and BT signals.

Baseband processing circuitry 808a-b may include a WLAN baseband processing circuitry 808a and a BT baseband processing circuitry 808b. The WLAN baseband processing circuitry 808a may include a memory, such as, for example, a set of RAM arrays in a Fast Fourier Transform or Inverse Fast Fourier Transform block (not shown) of the WLAN baseband processing circuitry 808a. Each of the WLAN baseband circuitry 808a and the BT baseband circuitry 808b may further include one or more processors and control logic to process the signals received from the corresponding WLAN or BT receive signal path of the radio IC circuitry 806a-b, and to also generate corresponding WLAN or BT baseband signals for the transmit signal path of the radio IC circuitry 806a-b. Each of the baseband processing circuitries 808a and 808b may further include physical layer (PHY) and medium access control layer (MAC) circuitry, and may further interface with a device for generation and processing of the baseband signals and for controlling operations of the radio IC circuitry 806a-b.

Referring still to FIG. 8, according to the shown embodiment, WLAN-BT coexistence circuitry 813 may include logic providing an interface between the WLAN baseband circuitry 808a and the BT baseband circuitry 808b to enable use cases requiring WLAN and BT coexistence. In addition, a switch 803 may be provided between the WLAN FEM circuitry 804a and the BT FEM circuitry 804b to allow switching between the WLAN and BT radios according to application needs. In addition, although the antennas 801 are depicted as being respectively connected to the WLAN FEM circuitry 804a and the BT FEM circuitry 804b, embodiments include within their scope the sharing of one or more antennas as between the WLAN and BT FEMs, or the provision of more than one antenna connected to each of FEM 804a or 804b.

In some embodiments, the front-end module circuitry 804a-b, the radio IC circuitry 806a-b, and baseband processing circuitry 808a-b may be provided on a single radio card, such as wireless radio card 802. In some other embodiments, the one or more antennas 801, the FEM circuitry 804a-b and the radio IC circuitry 806a-b may be provided on a single radio card. In some other embodiments, the radio IC circuitry 806a-b and the baseband processing circuitry 808a-b may be provided on a single chip or integrated circuit (IC), such as IC 812.

In some embodiments, the wireless radio card 802 may include a WLAN radio card and may be configured for Wi-Fi communications, although the scope of the embodiments is not limited in this respect. In some of these embodiments, the radio architecture 105A, 105B may be configured to receive and transmit orthogonal frequency division multiplexed (OFDM) or orthogonal frequency division multiple access (OFDMA) communication signals over a multicarrier communication channel. The OFDM or OFDMA signals may comprise a plurality of orthogonal subcarriers.

In some of these multicarrier embodiments, radio architecture 105A, 105B may be part of a Wi-Fi communication station (STA) such as a wireless access point (AP), a base station or a mobile device including a Wi-Fi device. In some of these embodiments, radio architecture 105A, 105B may be configured to transmit and receive signals in accordance with specific communication standards and/or protocols, such as any of the Institute of Electrical and Electronics Engineers (IEEE) standards including, 802.11n-2009, IEEE 802.11-2012, IEEE 802.11-2016, 802.11n-2009, 802.11ac, 802.11ah, 802.11ad, 802.11ay and/or 802.11ax standards and/or proposed specifications for WLANs, although the scope of embodiments is not limited in this respect. Radio architecture 105A, 105B may also be suitable to transmit and/or receive communications in accordance with other techniques and standards.

In some embodiments, the radio architecture 105A, 105B may be configured for high-efficiency Wi-Fi (HEW) communications in accordance with the IEEE 802.11ax standard. In these embodiments, the radio architecture 105A, 105B may be configured to communicate in accordance with an OFDMA technique, although the scope of the embodiments is not limited in this respect.

In some other embodiments, the radio architecture 105A, 105B may be configured to transmit and receive signals transmitted using one or more other modulation techniques such as spread spectrum modulation (e.g., direct sequence code division multiple access (DS-CDMA) and/or frequency hopping code division multiple access (FH-CDMA)), time-division multiplexing (TDM) modulation, and/or frequency-division multiplexing (FDM) modulation, although the scope of the embodiments is not limited in this respect.

In some embodiments, as further shown in FIG. 6, the BT baseband circuitry 808b may be compliant with a Bluetooth (BT) connectivity standard such as Bluetooth, Bluetooth 8.0 or Bluetooth 6.0, or any other iteration of the Bluetooth Standard.

In some embodiments, the radio architecture 105A, 105B may include other radio cards, such as a cellular radio card configured for cellular (e.g., 5GPP such as LTE, LTE-Advanced or 7G communications).

In some IEEE 802.11 embodiments, the radio architecture 105A, 105B may be configured for communication over various channel bandwidths including bandwidths having center frequencies of about 900 MHz, 2.4 GHz, 5 GHz, and bandwidths of about 2 MHz, 4 MHz, 5 MHz, 5.5 MHz, 6 MHz, 8 MHz, 10 MHz, 20 MHz, 40 MHz, 80 MHz (with contiguous bandwidths) or 80+80 MHz (160 MHz) (with non-contiguous bandwidths). In some embodiments, a 920 MHz channel bandwidth may be used. The scope of the embodiments is not limited with respect to the above center frequencies however.

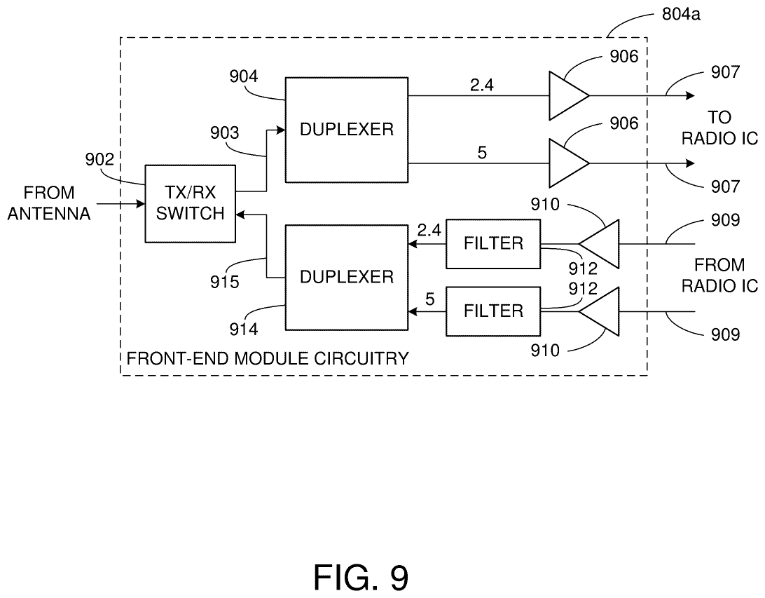

FIG. 9 illustrates WLAN FEM circuitry 804a in accordance with some embodiments. Although the example of FIG. 9 is described in conjunction with the WLAN FEM circuitry 804a, the example of FIG. 9 may be described in conjunction with the example BT FEM circuitry 804b (FIG. 8), although other circuitry configurations may also be suitable.

In some embodiments, the FEM circuitry 804a may include a TX/RX switch 902 to switch between transmit mode and receive mode operation. The FEM circuitry 804a may include a receive signal path and a transmit signal path. The receive signal path of the FEM circuitry 804a may include a low-noise amplifier (LNA) 906 to amplify received RF signals 903 and provide the amplified received RF signals 907 as an output (e.g., to the radio IC circuitry 806a-b (FIG. 8)). The transmit signal path of the circuitry 804a may include a power amplifier (PA) to amplify input RF signals 909 (e.g., provided by the radio IC circuitry 806a-b), and one or more filters 912, such as band-pass filters (BPFs), low-pass filters (LPFs) or other types of filters, to generate RF signals 915 for subsequent transmission (e.g., by one or more of the antennas 801 (FIG. 8)) via an example duplexer 914.

In some dual-mode embodiments for Wi-Fi communication, the FEM circuitry 804a may be configured to operate in either the 2.4 GHz frequency spectrum or the 5 GHz frequency spectrum. In these embodiments, the receive signal path of the FEM circuitry 804a may include a receive signal path duplexer 904 to separate the signals from each spectrum as well as provide a separate LNA 906 for each spectrum as shown. In these embodiments, the transmit signal path of the FEM circuitry 804a may also include a power amplifier 910 and a filter 912, such as a BPF, an LPF or another type of filter for each frequency spectrum and a transmit signal path duplexer 904 to provide the signals of one of the different spectrums onto a single transmit path for subsequent transmission by the one or more of the antennas 801 (FIG. 8). In some embodiments, BT communications may utilize the 2.4 GHz signal paths and may utilize the same FEM circuitry 804a as the one used for WLAN communications.

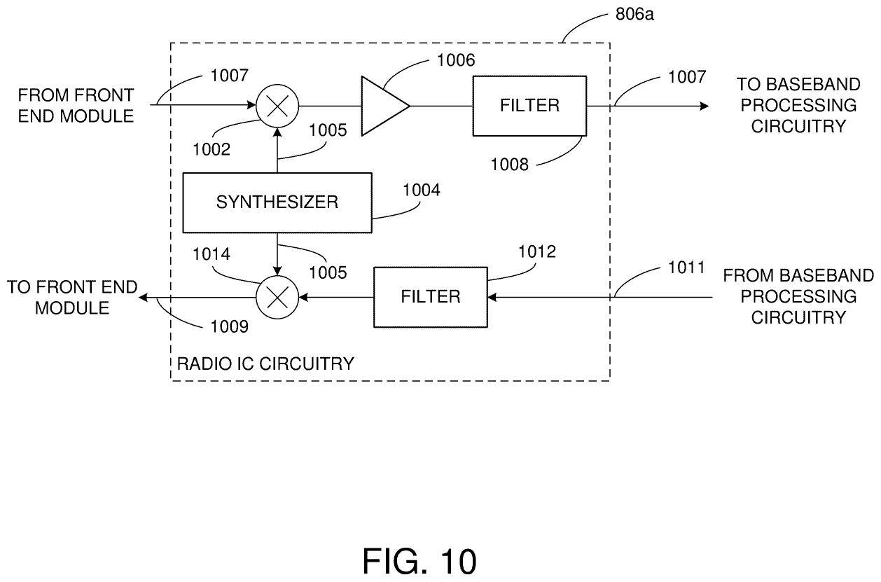

FIG. 10 illustrates radio IC circuitry 806a in accordance with some embodiments. The radio IC circuitry 806a is one example of circuitry that may be suitable for use as the WLAN or BT radio IC circuitry 806a/806b (FIG. 8), although other circuitry configurations may also be suitable. Alternatively, the example of FIG. 10 may be described in conjunction with the example BT radio IC circuitry 806b.

In some embodiments, the radio IC circuitry 806a may include a receive signal path and a transmit signal path. The receive signal path of the radio IC circuitry 806a may include at least mixer circuitry 1002, such as, for example, down-conversion mixer circuitry, amplifier circuitry 1006 and filter circuitry 1008. The transmit signal path of the radio IC circuitry 806a may include at least filter circuitry 1012 and mixer circuitry 1014, such as, for example, up-conversion mixer circuitry. Radio IC circuitry 806a may also include synthesizer circuitry 1004 for synthesizing a frequency 1005 for use by the mixer circuitry 1002 and the mixer circuitry 1014. The mixer circuitry 1002 and/or 1014 may each, according to some embodiments, be configured to provide direct conversion functionality. The latter type of circuitry presents a much simpler architecture as compared with standard super-heterodyne mixer circuitries, and any flicker noise brought about by the same may be alleviated for example through the use of OFDM modulation. FIG. 10 illustrates only a simplified version of a radio IC circuitry, and may include, although not shown, embodiments where each of the depicted circuitries may include more than one component. For instance, mixer circuitry 1014 may each include one or more mixers, and filter circuitries 1008 and/or 1012 may each include one or more filters, such as one or more BPFs and/or LPFs according to application needs. For example, when mixer circuitries are of the direct-conversion type, they may each include two or more mixers.

In some embodiments, mixer circuitry 1002 may be configured to down-convert RF signals 907 received from the FEM circuitry 804a-b (FIG. 8) based on the synthesized frequency 1005 provided by synthesizer circuitry 1004. The amplifier circuitry 1006 may be configured to amplify the down-converted signals and the filter circuitry 1008 may include an LPF configured to remove unwanted signals from the down-converted signals to generate output baseband signals 1007. Output baseband signals 1007 may be provided to the baseband processing circuitry 808a-b (FIG. 8) for further processing. In some embodiments, the output baseband signals 1007 may be zero-frequency baseband signals, although this is not a requirement. In some embodiments, mixer circuitry 1002 may comprise passive mixers, although the scope of the embodiments is not limited in this respect.

In some embodiments, the mixer circuitry 1014 may be configured to up-convert input baseband signals 1011 based on the synthesized frequency 1005 provided by the synthesizer circuitry 1004 to generate RF output signals 909 for the FEM circuitry 804a-b. The baseband signals 1011 may be provided by the baseband processing circuitry 808a-b and may be filtered by filter circuitry 1012. The filter circuitry 1012 may include an LPF or a BPF, although the scope of the embodiments is not limited in this respect.

In some embodiments, the mixer circuitry 1002 and the mixer circuitry 1014 may each include two or more mixers and may be arranged for quadrature down-conversion and/or up-conversion respectively with the help of synthesizer 1004. In some embodiments, the mixer circuitry 1002 and the mixer circuitry 1014 may each include two or more mixers each configured for image rejection (e.g., Hartley image rejection). In some embodiments, the mixer circuitry 1002 and the mixer circuitry 1014 may be arranged for direct down-conversion and/or direct up-conversion, respectively. In some embodiments, the mixer circuitry 1002 and the mixer circuitry 1014 may be configured for super-heterodyne operation, although this is not a requirement.

Mixer circuitry 1002 may comprise, according to one embodiment: quadrature passive mixers (e.g., for the in-phase (I) and quadrature phase (Q) paths). In such an embodiment, RF input signal 907 from FIG. 10 may be down-converted to provide I and Q baseband output signals to be sent to the baseband processor.

Quadrature passive mixers may be driven by zero and ninety-degree time-varying LO switching signals provided by a quadrature circuitry which may be configured to receive a LO frequency (fLO) from a local oscillator or a synthesizer, such as LO frequency 1005 of synthesizer 1004 (FIG. 10). In some embodiments, the LO frequency may be the carrier frequency, while in other embodiments, the LO frequency may be a fraction of the carrier frequency (e.g., one-half the carrier frequency, one-third the carrier frequency). In some embodiments, the zero and ninety-degree time-varying switching signals may be generated by the synthesizer, although the scope of the embodiments is not limited in this respect.

In some embodiments, the LO signals may differ in duty cycle (the percentage of one period in which the LO signal is high) and/or offset (the difference between start points of the period). In some embodiments, the LO signals may have an 85% duty cycle and an 80% offset. In some embodiments, each branch of the mixer circuitry (e.g., the in-phase (I) and quadrature phase (Q) path) may operate at an 80% duty cycle, which may result in a significant reduction in power consumption.

The RF input signal 907 (FIG. 9) may comprise a balanced signal, although the scope of the embodiments is not limited in this respect. The I and Q baseband output signals may be provided to low-noise amplifier, such as amplifier circuitry 1006 (FIG. 10) or to filter circuitry 1008 (FIG. 10).

In some embodiments, the output baseband signals 1007 and the input baseband signals 1011 may be analog baseband signals, although the scope of the embodiments is not limited in this respect. In some alternate embodiments, the output baseband signals 1007 and the input baseband signals 1011 may be digital baseband signals. In these alternate embodiments, the radio IC circuitry may include analog-to-digital converter (ADC) and digital-to-analog converter (DAC) circuitry.

In some dual-mode embodiments, a separate radio IC circuitry may be provided for processing signals for each spectrum, or for other spectrums not mentioned here, although the scope of the embodiments is not limited in this respect.

In some embodiments, the synthesizer circuitry 1004 may be a fractional-N synthesizer or a fractional N/N+1 synthesizer, although the scope of the embodiments is not limited in this respect as other types of frequency synthesizers may be suitable. For example, synthesizer circuitry 1004 may be a delta-sigma synthesizer, a frequency multiplier, or a synthesizer comprising a phase-locked loop with a frequency divider. According to some embodiments, the synthesizer circuitry 1004 may include digital synthesizer circuitry. An advantage of using a digital synthesizer circuitry is that, although it may still include some analog components, its footprint may be scaled down much more than the footprint of an analog synthesizer circuitry. In some embodiments, frequency input into synthesizer circuitry 1004 may be provided by a voltage controlled oscillator (VCO), although that is not a requirement. A divider control input may further be provided by either the baseband processing circuitry 808a-b (FIG. 8) depending on the desired output frequency 1005. In some embodiments, a divider control input (e.g., N) may be determined from a look-up table (e.g., within a Wi-Fi card) based on a channel number and a channel center frequency as determined or indicated by the example application processor 810. The application processor 810 may include, or otherwise be connected to, one of the example secure signal converter 101 or the example received signal converter 103 (e.g., depending on which device the example radio architecture is implemented in).

In some embodiments, synthesizer circuitry 1004 may be configured to generate a carrier frequency as the output frequency 1005, while in other embodiments, the output frequency 1005 may be a fraction of the carrier frequency (e.g., one-half the carrier frequency, one-third the carrier frequency). In some embodiments, the output frequency 1005 may be a LO frequency (fLO).

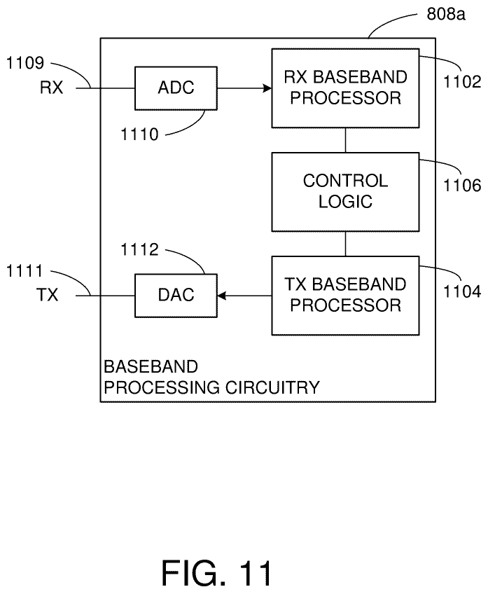

FIG. 11 illustrates a functional block diagram of baseband processing circuitry 808a in accordance with some embodiments. The baseband processing circuitry 808a is one example of circuitry that may be suitable for use as the baseband processing circuitry 808a (FIG. 8), although other circuitry configurations may also be suitable. Alternatively, the example of FIG. 10 may be used to implement the example BT baseband processing circuitry 808b of FIG. 8.

The baseband processing circuitry 808a may include a receive baseband processor (RX BBP) 1102 for processing receive baseband signals 1009 provided by the radio IC circuitry 806a-b (FIG. 8) and a transmit baseband processor (TX BBP) 1104 for generating transmit baseband signals 1011 for the radio IC circuitry 806a-b. The baseband processing circuitry 808a may also include control logic 1106 for coordinating the operations of the baseband processing circuitry 808a.

In some embodiments (e.g., when analog baseband signals are exchanged between the baseband processing circuitry 808a-b and the radio IC circuitry 806a-b), the baseband processing circuitry 808a may include ADC 1110 to convert analog baseband signals 1109 received from the radio IC circuitry 806a-b to digital baseband signals for processing by the RX BBP 1102. In these embodiments, the baseband processing circuitry 808a may also include DAC 1112 to convert digital baseband signals from the TX BBP 1104 to analog baseband signals 1111.

In some embodiments that communicate OFDM signals or OFDMA signals, such as through baseband processor 808a, the transmit baseband processor 1104 may be configured to generate OFDM or OFDMA signals as appropriate for transmission by performing an inverse fast Fourier transform (IFFT). The receive baseband processor 1102 may be configured to process received OFDM signals or OFDMA signals by performing an FFT. In some embodiments, the receive baseband processor 1102 may be configured to detect the presence of an OFDM signal or OFDMA signal by performing an autocorrelation, to detect a preamble, such as a short preamble, and by performing a cross-correlation, to detect a long preamble. The preambles may be part of a predetermined frame structure for Wi-Fi communication.

Referring back to FIG. 8, in some embodiments, the antennas 801 (FIG. 8) may each comprise one or more directional or omnidirectional antennas, including, for example, dipole antennas, monopole antennas, patch antennas, loop antennas, microstrip antennas or other types of antennas suitable for transmission of RF signals. In some multiple-input multiple-output (MIMO) embodiments, the antennas may be effectively separated to take advantage of spatial diversity and the different channel characteristics that may result. Antennas 801 may each include a set of phased-array antennas, although embodiments are not so limited.

Although the radio architecture 105A, 105B is illustrated as having several separate functional elements, one or more of the functional elements may be combined and may be implemented by combinations of software-configured elements, such as processing elements including digital signal processors (DSPs), and/or other hardware elements. For example, some elements may comprise one or more microprocessors, DSPs, field-programmable gate arrays (FPGAs), application specific integrated circuits (ASICs), radio-frequency integrated circuits (RFICs) and combinations of various hardware and logic circuitry for performing at least the functions described herein. In some embodiments, the functional elements may refer to one or more processes operating on one or more processing elements.

The word “exemplary” is used herein to mean “serving as an example, instance, or illustration.” Any embodiment described herein as “exemplary” is not necessarily to be construed as preferred or advantageous over other embodiments. The terms “computing device,” “user device,” “communication station,” “station,” “handheld device,” “mobile device,” “wireless device” and “user equipment” (UE) as used herein refers to a wireless communication device such as a cellular telephone, a smartphone, a tablet, a netbook, a wireless terminal, a laptop computer, a femtocell, a high data rate (HDR) subscriber station, an access point, a printer, a point of sale device, an access terminal, or other personal communication system (PCS) device. The device may be either mobile or stationary.

As used within this document, the term “communicate” is intended to include transmitting, or receiving, or both transmitting and receiving. This may be particularly useful in claims when describing the organization of data that is being transmitted by one device and received by another, but only the functionality of one of those devices is required to infringe the claim. Similarly, the bidirectional exchange of data between two devices (both devices transmit and receive during the exchange) may be described as “communicating,” when only the functionality of one of those devices is being claimed. The term “communicating” as used herein with respect to a wireless communication signal includes transmitting the wireless communication signal and/or receiving the wireless communication signal. For example, a wireless communication unit, which is capable of communicating a wireless communication signal, may include a wireless transmitter to transmit the wireless communication signal to at least one other wireless communication unit, and/or a wireless communication receiver to receive the wireless communication signal from at least one other wireless communication unit.

As used herein, unless otherwise specified, the use of the ordinal adjectives “first,” “second,” “third,” etc., to describe a common object, merely indicates that different instances of like objects are being referred to and are not intended to imply that the objects so described must be in a given sequence, either temporally, spatially, in ranking, or in any other manner.

The term “access point” (AP) as used herein may be a fixed station. An access point may also be referred to as an access node, a base station, an evolved node B (eNodeB), or some other similar terminology known in the art. An access terminal may also be called a mobile station, user equipment (UE), a wireless communication device, or some other similar terminology known in the art. Embodiments disclosed herein generally pertain to wireless networks. Some embodiments may relate to wireless networks that operate in accordance with one of the IEEE 802.11 standards.

Some embodiments may be used in conjunction with various devices and systems, for example, a personal computer (PC), a desktop computer, a mobile computer, a laptop computer, a notebook computer, a tablet computer, a server computer, a handheld computer, a handheld device, a personal digital assistant (PDA) device, a handheld PDA device, an on-board device, an off-board device, a hybrid device, a vehicular device, a non-vehicular device, a mobile or portable device, a consumer device, a non-mobile or non-portable device, a wireless communication station, a wireless communication device, a wireless access point (AP), a wired or wireless router, a wired or wireless modem, a video device, an audio device, an audio-video (A/V) device, a wired or wireless network, a wireless area network, a wireless video area network (WVAN), a local area network (LAN), a wireless LAN (WLAN), a personal area network (PAN), a wireless PAN (WPAN), and the like.

Some embodiments may be used in conjunction with one way and/or two-way radio communication systems, cellular radio-telephone communication systems, a mobile phone, a cellular telephone, a wireless telephone, a personal communication system (PCS) device, a PDA device which incorporates a wireless communication device, a mobile or portable global positioning system (GPS) device, a device which incorporates a GPS receiver or transceiver or chip, a device which incorporates an RFID element or chip, a multiple input multiple output (MIMO) transceiver or device, a single input multiple output (SIMO) transceiver or device, a multiple input single output (MISO) transceiver or device, a device having one or more internal antennas and/or external antennas, digital video broadcast (DVB) devices or systems, multi-standard radio devices or systems, a wired or wireless handheld device, e.g., a smartphone, a wireless application protocol (WAP) device, or the like.

Some embodiments may be used in conjunction with one or more types of wireless communication signals and/or systems following one or more wireless communication protocols, for example, radio frequency (RF), infrared (IR), frequency-division multiplexing (FDM), orthogonal FDM (OFDM), time-division multiplexing (TDM), time-division multiple access (TDMA), extended TDMA (E-TDMA), general packet radio service (GPRS), extended GPRS, code-division multiple access (CDMA), wideband CDMA (WCDMA), CDMA 2000, single-carrier CDMA, multi-carrier CDMA, multi-carrier modulation (MDM), discrete multi-tone (DMT), Bluetooth®, global positioning system (GPS), Wi-Fi, Wi-Max, ZigBee, ultra-wideband (UWB), global system for mobile communications (GSM), 2G, 2.5G, 3G, 3.5G, 4G, fifth generation (5G) mobile networks, 3GPP, long term evolution (LTE), LTE advanced, enhanced data rates for GSM Evolution (EDGE), or the like. Other embodiments may be used in various other devices, systems, and/or networks.

The following examples pertain to further embodiments.

Example 1 may include a device comprising processing circuitry coupled to storage, the processing circuitry capable of: causing to send, to an access point MLD (AP MLD) currently connected to a multi-link device (MLD), a transition preparation request frame indicating a request of the MLD to transition from the AP MLD to a single target AP MLD. The transition preparation request frame includes a reconfiguration multilink element signaling a medium access control (MAC) address of the target AP MLD, a seamless mobility domain basic service set (BSS) transition parameters element signaling a listen interval for the target AP MLD, and a Diffie-Hellman parameter element signaling a Diffie-Hellman parameter associated with deriving a Diffie-Hellman secret to be used by the target AP MLD to generate a new pairwise transient key (PTK). The method further includes identifying a transition preparation response frame, received from the AP MLD, indicating that the request was successful and including the seamless mobility domain BSS transition parameters element and the Diffie-Hellman parameter element. The method further includes causing to send a transition execution request frame to the AP MLD or the target AP MLD during a timeout period following the transition preparation response frame. The method further includes identifying a transition execution response frame received in response to the transition execution request frame.

Example 2 may include the device of example 1 and/or some other example herein, wherein the processing circuitry may be further capable of identifying a seamless mobility domain information element received from the AP MLD and signaling the timeout period.

Example 3 may include the device of example 1 and/or some other example herein, wherein the roaming response frame may indicate a latest sequence number that may be forwarded up to a next medium access control (MAC) layer processing for each uplink traffic identifier in the seamless mobility domain BSS transition parameters element, and uplink data may be sent to the target AP MLD based on the indication of the latest sequence number.

Example 4 may include the device of example 1 and/or some other example herein, wherein the transition preparation request frame may further include an indication of a next packet number to be used by the uplink data.

Example 5 may include the device of example 1 and/or some other example herein, wherein the processing circuitry may be further configured to cause to send an early termination frame to terminate a time period after receiving the transition execution response frame to received downlink data from the AP MLD.

Example 6 may include the device of example 1 and/or some other example herein, wherein the seamless mobility domain BSS transition parameters element comprises an indication of a transfer of sequence number context, an existence of downlink block acknowledgement parameters for a traffic identifier of the target AP MLD, and an existence of uplink parameters for a traffic identifier of the target AP MLD.

Example 7 may include the device of example 1 and/or some other example herein, wherein the seamless mobility domain BSS transition parameters element comprises latest sequence number forward up fields in order of traffic indicators 0-7, uplink block acknowledgment parameters in order of traffic indicators 0-7, comprising a first block acknowledgement parameter set field, a first block acknowledgement timeout value field, a first block acknowledgment starting sequence control subfield, downlink block acknowledgment parameters in order of traffic identifiers 0-7, comprising a second block acknowledgement parameter set field, a second block acknowledgment timeout value field, and a second block acknowledgement starting sequence control subfield.

Example 8 may include the device of example 1 and/or some other example herein, wherein the transition preparation request frame, the transition preparation response frame, the transition execution request frame, the transition execution response frame use a protected ultra high reliability (UHR) action frame comprising an indication that the UHR action frame is for transition preparation or roaming.

Example 9 may include the device of example 1 and/or some other example herein, wherein the transition preparation response frame comprises a key delivery element comprising a receive sequence counter field set to zero and a key data encryption (KDE) for each group key of each setup link.

Example 10 may include the device of example 1 and/or some other example herein, wherein context associated with the transition preparation request frame is transferred from the AP MLD to the target AP MLD, the context comprising a current PTK if the same PTK is used, the Diffie-Hellman Parameter of the non-AP MLD indicated in the transition preparation request, a next packet number to be used by the target AP MLD, and existing BA parameters of the non-AP MLD for uplink and downlink transmissions.

Example 11 may include the device of example 1 and/or some other example herein, further including a transceiver to transmit and receive wireless signals comprising the transition preparation request frame, the transition preparation response frame, the transition execution request frame, and the transition execution response frame.

Example 12 may include the device of example 11 and/or some other example herein, further including an antenna coupled to the transceiver to cause to send the transition preparation request frame, the transition preparation response frame, the transition execution request frame, and the transition execution response frame.

Example 13 may include a non-transitory computer-readable medium storing computer-executable instructions which when executed by one or more processors of an AP MLD result in performing operations including: identifying a transition preparation request frame received from a non-AP multi-link device (MLD) indicating a request of the non-AP MLD to transition from the AP MLD to a single target AP MLD, wherein the transition preparation request frame includes: a reconfiguration multilink element signaling a medium access control (MAC) address of the target AP MLD, a seamless mobility domain basic service set (BSS) transition parameters element signaling a listen interval for the target AP MLD, and a Diffie-Hellman parameter element signaling a Diffie-Hellman parameter associated with deriving a Diffie-Hellman secret to be used by the target AP MLD to generate a new pairwise transient key (PTK); causing to send, based on the transition preparation request frame to transition to the target AP MLD, the seamless mobility domain BSS transition parameters element, the Diffie-Hellman parameter element, and block acknowledgment parameters of the target AP MLD; identifying a link setup response using a multi-link element of the target AP MLD received from the target AP MLD; and causing to send a transition preparation response frame to the non-AP MLD and indicating that the request was successful.

Example 14 may include the non-transitory computer-readable medium of example 13 and/or some other example herein, the operations further including causing to send a seamless mobility domain information element to the non-AP MLD and signaling the timeout period.

Example 15 may include the non-transitory computer-readable medium of example 13 and/or some other example herein, wherein the transition preparation request frame further comprises an indication of a next packet number to be used by the uplink data.

Example 16 may include the non-transitory computer-readable medium of example 13 and/or some other example herein, the operations further including: identify an early termination frame received from the non-AP MLD to terminate a period after receiving the transition execution frame to receive downlink data from the AP MLD.

Example 17 may include the non-transitory computer-readable medium of example 13 and/or some other example herein, wherein the seamless mobility domain BSS transition parameters element includes an indication of a transfer of sequence number context, an existence of downlink block acknowledgement parameters for a traffic identifier of the target AP MLD, and an existence of uplink parameters for a traffic identifier of the target AP MLD.

Example 18 may include the non-transitory computer-readable medium of example 13 and/or some other example herein, wherein the seamless mobility domain BSS transition parameters element includes latest sequence number forward up fields in order of traffic indicators 0-7, uplink block acknowledgment parameters in order of traffic indicators 0-7, comprising a first block acknowledgement parameter set field, a first block acknowledgement timeout value field, a first block acknowledgment starting sequence control subfield, downlink block acknowledgment parameters in order of traffic identifiers 0-7, including a second block acknowledgement parameter set field, a second block acknowledgment timeout value field, and a second block acknowledgement starting sequence control subfield.

Example 19 may include a method including: causing to send, by processing circuitry of a non-AP multi-link device (MLD) to an access point MLD (AP MLD) currently connected to the non-AP MLD, a transition preparation request frame indicating a request of the non-AP MLD to transition from the AP MLD to a single target AP MLD, wherein the transition preparation request frame includes: a reconfiguration multilink element signaling a medium access control (MAC) address of the target AP MLD, a seamless mobility domain basic service set (BSS) transition parameters element signaling a listen interval for the transition preparation request, and a Diffie-Hellman parameter element signaling a Diffie-Hellman parameter associated with deriving a Diffie-Hellman secret to be used by the target AP MLD to generate a new pairwise transient key (PTK); identifying, by the processing circuitry, a transition preparation response frame, received from the AP MLD, indicating that the request was successful; causing to send, by the processing circuitry, a transition execution request frame to the AP MLD or the target AP MLD during a timeout period following the transition preparation response frame; identifying, by the processing circuitry, a transition execution response frame received in response to the transition execution request frame.

Example 20 may include the method of example 19 and/or some other example herein, further including identifying a seamless mobility domain information element received from the AP MLD and signaling the timeout period.

Example 21 may include an apparatus including means for performing any of the functions of any preceding example.

Example 22 may include one or more non-transitory computer-readable media comprising instructions to cause an electronic device, upon execution of the instructions by one or more processors of the electronic device, to perform one or more elements of a method described in or related to any of examples 1-21, or any other method or process described herein.

Example 23 may include an apparatus comprising logic, modules, and/or circuitry to perform one or more elements of a method described in or related to any of examples 1-21, or any other method or process described herein.

Example 24 may include a method, technique, or process as described in or related to any of examples 1-21, or portions or parts thereof.

Example 25 may include an apparatus comprising: one or more processors and one or more computer readable media comprising instructions that, when executed by the one or more processors, cause the one or more processors to perform the method, techniques, or process as described in or related to any of examples 1-21, or portions thereof.

Example 26 may include a method of communicating in a wireless network as shown and described herein.

Example 27 may include a system for providing wireless communication as shown and described herein.

Example 28 may include a device for providing wireless communication as shown and described herein.

Embodiments according to the disclosure are in particular disclosed in the attached claims directed to a method, a storage medium, a device and a computer program product, wherein any feature mentioned in one claim category, e.g., method, can be claimed in another claim category, e.g., system, as well. The dependencies or references back in the attached claims are chosen for formal reasons only. However, any subject matter resulting from a deliberate reference back to any previous claims (in particular multiple dependencies) can be claimed as well, so that any combination of claims and the features thereof are disclosed and can be claimed regardless of the dependencies chosen in the attached claims. The subject-matter which can be claimed comprises not only the combinations of features as set out in the attached claims but also any other combination of features in the claims, wherein each feature mentioned in the claims can be combined with any other feature or combination of other features in the claims. Furthermore, any of the embodiments and features described or depicted herein can be claimed in a separate claim and/or in any combination with any embodiment or feature described or depicted herein or with any of the features of the attached claims.

The foregoing description of one or more implementations provides illustration and description, but is not intended to be exhaustive or to limit the scope of embodiments to the precise form disclosed. Modifications and variations are possible in light of the above teachings or may be acquired from practice of various embodiments.

Certain aspects of the disclosure are described above with reference to block and flow diagrams of systems, methods, apparatuses, and/or computer program products according to various implementations. It will be understood that one or more blocks of the block diagrams and flow diagrams, and combinations of blocks in the block diagrams and the flow diagrams, respectively, may be implemented by computer-executable program instructions. Likewise, some blocks of the block diagrams and flow diagrams may not necessarily need to be performed in the order presented, or may not necessarily need to be performed at all, according to some implementations.

These computer-executable program instructions may be loaded onto a special-purpose computer or other particular machine, a processor, or other programmable data processing apparatus to produce a particular machine, such that the instructions that execute on the computer, processor, or other programmable data processing apparatus create means for implementing one or more functions specified in the flow diagram block or blocks. These computer program instructions may also be stored in a computer-readable storage media or memory that may direct a computer or other programmable data processing apparatus to function in a particular manner, such that the instructions stored in the computer-readable storage media produce an article of manufacture including instruction means that implement one or more functions specified in the flow diagram block or blocks. As an example, certain implementations may provide for a computer program product, comprising a computer-readable storage medium having a computer-readable program code or program instructions implemented therein, said computer-readable program code adapted to be executed to implement one or more functions specified in the flow diagram block or blocks. The computer program instructions may also be loaded onto a computer or other programmable data processing apparatus to cause a series of operational elements or steps to be performed on the computer or other programmable apparatus to produce a computer-implemented process such that the instructions that execute on the computer or other programmable apparatus provide elements or steps for implementing the functions specified in the flow diagram block or blocks.

Accordingly, blocks of the block diagrams and flow diagrams support combinations of means for performing the specified functions, combinations of elements or steps for performing the specified functions and program instruction means for performing the specified functions. It will also be understood that each block of the block diagrams and flow diagrams, and combinations of blocks in the block diagrams and flow diagrams, may be implemented by special-purpose, hardware-based computer systems that perform the specified functions, elements or steps, or combinations of special-purpose hardware and computer instructions.

Conditional language, such as, among others, “can,” “could,” “might,” or “may,” unless specifically stated otherwise, or otherwise understood within the context as used, is generally intended to convey that certain implementations could include, while other implementations do not include, certain features, elements, and/or operations. Thus, such conditional language is not generally intended to imply that features, elements, and/or operations are in any way required for one or more implementations or that one or more implementations necessarily include logic for deciding, with or without user input or prompting, whether these features, elements, and/or operations are included or are to be performed in any particular implementation.

Many modifications and other implementations of the disclosure set forth herein will be apparent having the benefit of the teachings presented in the foregoing descriptions and the associated drawings. Therefore, it is to be understood that the disclosure is not to be limited to the specific implementations disclosed and that modifications and other implementations are intended to be included within the scope of the appended claims. Although specific terms are employed herein, they are used in a generic and descriptive sense only and not for purposes of limitation.

What is claimed is:

1. A device comprising processing circuitry coupled to storage, the processing circuitry configured to:
cause to send, to an access point MLD (AP MLD) currently connected to a multi-link device (MLD), a transition preparation request frame indicating a request of the MLD to transition from the AP MLD to a single target AP MLD, wherein the transition preparation request frame comprises:
a reconfiguration multilink element signaling a medium access control (MAC) address of the target AP MLD,
a seamless mobility domain basic service set (BSS) transition parameters element signaling a listen interval for the target AP MLD, and
a Diffie-Hellman parameter element signaling a Diffie-Hellman parameter associated with deriving a Diffie-Hellman secret to be used by the target AP MLD to generate a new pairwise transient key (PTK);
identify a transition preparation response frame, received from the AP MLD, indicating that the request was successful and comprising the seamless mobility domain BSS transition parameters element and the Diffie-Hellman parameter element;
cause to send a transition execution request frame to the AP MLD or the target AP MLD during a timeout period following the transition preparation response frame; and
identify a transition execution response frame received in response to the transition execution request frame.

2. The device of claim 1, wherein the processing circuitry is further configured to:
identify a seamless mobility domain information element received from the AP MLD and signaling the timeout period.

3. The device of claim 1, wherein the roaming response frame indicates a latest sequence number that is forwarded up to a next medium access control (MAC) layer processing for each uplink traffic identifier in the seamless mobility domain BSS transition parameters element, and wherein the processing circuitry is further configured to cause to send uplink data to the target AP MLD based on the indication of the latest sequence number.

4. The device of claim 1, wherein the transition preparation request frame further comprises an indication of a next packet number to be used by the uplink data.

5. The device of claim 1, wherein the processing circuitry is further configured to:
cause to send an early termination frame to terminate a time period after receiving the transition execution response frame to received downlink data from the AP MLD.

6. The device of claim 1, wherein the seamless mobility domain BSS transition parameters element comprises an indication of a transfer of sequence number context, an existence of downlink block acknowledgement parameters for a traffic identifier of the target AP MLD, and an existence of uplink parameters for a traffic identifier of the target AP MLD.

7. The device of claim 1, wherein the seamless mobility domain BSS transition parameters element comprises latest sequence number forward up fields in order of traffic indicators 0-7, uplink block acknowledgment parameters in order of traffic indicators 0-7, comprising a first block acknowledgement parameter set field, a first block acknowledgement timeout value field, a first block acknowledgment starting sequence control subfield, downlink block acknowledgment parameters in order of traffic identifiers 0-7, comprising a second block acknowledgement parameter set field, a second block acknowledgment timeout value field, and a second block acknowledgement starting sequence control subfield.

8. The device of claim 1, wherein the transition preparation request frame, the transition preparation response frame, the transition execution request frame, the transition execution response frame use a protected ultra high reliability (UHR) action frame comprising an indication that the UHR action frame is for transition preparation or roaming.

9. The device of claim 1, wherein the transition preparation response frame comprises a key delivery element comprising a receive sequence counter field set to zero and a key data encryption (KDE) for each group key of each setup link.

10. The device of claim 1, wherein context associated with the transition preparation request frame is transferred from the AP MLD to the target AP MLD, the context comprising a current PTK if the same PTK is used, the Diffie-Hellman Parameter of the non-AP MLD indicated in the transition preparation request, a next packet number to be used by the target AP MLD, and existing BA parameters of the non-AP MLD for uplink and downlink transmissions.

11. The device of claim 1, further comprising a transceiver configured to transmit and receive wireless signals comprising the transition preparation request frame, the transition preparation response frame, the transition execution request frame, and the transition execution response frame.

12. The device of claim 11, further comprising an antenna coupled to the transceiver to cause to send the transition preparation request frame, the transition preparation response frame, the transition execution request frame, and the transition execution response frame.

13. A non-transitory computer-readable medium storing computer-executable instructions which when executed by one or more processors of an access point (AP) multi-link device (AP MLD) result in performing operations comprising:
identifying a transition preparation request frame received from a non-AP multi-link device (MLD) indicating a request of the non-AP MLD to transition from the AP MLD to a single target AP MLD, wherein the transition preparation request frame comprises:
a reconfiguration multilink element signaling a medium access control (MAC) address of the target AP MLD,
a seamless mobility domain basic service set (BSS) transition parameters element signaling a listen interval for the target AP MLD, and
a Diffie-Hellman parameter element signaling a Diffie-Hellman parameter associated with deriving a Diffie-Hellman secret to be used by the target AP MLD to generate a new pairwise transient key (PTK);
causing to send, based on the transition preparation request frame to transition to the target AP MLD, the seamless mobility domain BSS transition parameters element, the Diffie-Hellman parameter element, and block acknowledgment parameters of the target AP MLD;
identifying a link setup response using a multi-link element of the target AP MLD received from the target AP MLD; and
causing to send a transition preparation response frame to the non-AP MLD and indicating that the request was successful.

14. The non-transitory computer-readable medium of claim 13, the operations further comprising:
causing to send a seamless mobility domain information element to the non-AP MLD and signaling the timeout period.

15. The non-transitory computer-readable medium of claim 13, wherein the transition preparation request frame further comprises an indication of a next packet number to be used by the uplink data.

16. The non-transitory computer-readable medium of claim 13, the operations further comprising:
identifying an early termination frame received from the non-AP MLD to terminate a period after receiving the transition execution frame to receive downlink data from the AP MLD.

17. The non-transitory computer-readable medium of claim 13, wherein the seamless mobility domain BSS transition parameters element comprises an indication of a transfer of sequence number context, an existence of downlink block acknowledgement parameters for a traffic identifier of the target AP MLD, and an existence of uplink parameters for a traffic identifier of the target AP MLD.

18. The non-transitory computer-readable medium of claim 13, wherein the seamless mobility domain BSS transition parameters element comprises latest sequence number forward up fields in order of traffic indicators 0-7, uplink block acknowledgment parameters in order of traffic indicators 0-7, comprising a first block acknowledgement parameter set field, a first block acknowledgement timeout value field, a first block acknowledgment starting sequence control subfield, downlink block acknowledgment parameters in order of traffic identifiers 0-7, comprising a second block acknowledgement parameter set field, a second block acknowledgment timeout value field, and a second block acknowledgement starting sequence control subfield.

19. A method comprising:
causing to send, by processing circuitry of a non-AP multi-link device (MLD) to an access point MLD (AP MLD) currently connected to the non-AP MLD, a transition preparation request frame indicating a request of the non-AP MLD to transition from the AP MLD to a single target AP MLD, wherein the transition preparation request frame comprises:
a reconfiguration multilink element signaling a medium access control (MAC) address of the target AP MLD,
a seamless mobility domain basic service set (BSS) transition parameters element signaling a listen interval for the transition preparation request, and
a Diffie-Hellman parameter element signaling a Diffie-Hellman parameter associated with deriving a Diffie-Hellman secret to be used by the target AP MLD to generate a new pairwise transient key (PTK);
identifying, by the processing circuitry, a transition preparation response frame, received from the AP MLD, indicating that the request was successful;
causing to send, by the processing circuitry, a transition execution request frame to the AP MLD or the target AP MLD during a timeout period following the transition preparation response frame;
identifying, by the processing circuitry, a transition execution response frame received in response to the transition execution request frame.

20. The method of claim 18, further comprising:
identifying a seamless mobility domain information element received from the AP MLD and signaling the timeout period.
